(19) United States
(12) Patent Application Publication
(10) Pub. No.: US 2011/0233821 A1
(43) Pub. Date: Sep. 29, 2011

(54) COMPRESSION RESIN SEALING AND MOLDING METHOD FOR ELECTRONIC COMPONENT AND APPARATUS THEREFOR

(75) Inventors: Kazuhiko Bandoh, Kyoto (JP); Keiji Maeda, Kyoto (JP); Kunihiko Fujiwara, Kyoto (JP); Noritoshi Nakano, Kyoto (JP)

(73) Assignee: TOWA CORPORATION, Kyoto-shi, Kyoto (JP)

(21) Appl. No.: 13/121,554

(22) PCT Filed: Sep. 25, 2009
(86) PCT No.: PCT/JP2009/066606

§ 371 Date: Jun. 20, 2011

(30) Foreign Application Priority Data
Sep. 30, 2008 (JP) 2008-252623
Sep. 30, 2008 (JP) 2008-252624

(51) Int. Cl. B29C 45/14; B29C 47/88

(52) U.S. Cl. 264/272.11; 425/144

(57) ABSTRACT

A compression resin sealing apparatus includes cooling means (64, 104) for each of an upper die (6) and a lower die (10). A gate nozzle (15) including cooling means (154a) is provided in the upper die (6). A cavity (106) for mounting a single substrate is provided in the lower die (10). In this apparatus, a liquid thermosetting resin material (R) in a required amount is supplied into the cavity (106) through the gate nozzle (15). Then, a substrate is supplied between the upper die (6) and the lower die (10), and the upper die (6) and the lower die (10) are clamped to each other. As a result, an electronic component on the substrate is immersed in the liquid thermosetting resin material (R) in the cavity (106). That is, compression resin molding is performed. Here, a temperature of the liquid thermosetting resin material (R) is controlled by the gate nozzle (15) and the cooling means (154a, 64, 104).

### TECHNICAL FIELD

The present invention relates to a compression resin sealing and molding method for sealing and molding a small electronic component such as a semiconductor device with a resin material, and a compression resin sealing and molding apparatus using this method. More particularly, the present invention relates to reducing size and weight of an overall structure of a compression resin sealing and molding apparatus, and allowing efficient compression resin sealing and molding operation even with use of a thermosetting resin material which tends to be readily cured during resin molding.

### BACKGROUND ART

A compression resin sealing and molding (commonly referred to as “compression molding”) method has been employed as means for sealing and molding an electronic component mounted on a substrate with resin.

The following steps are performed in this method, for example. First, a liquid thermosetting resin material is supplied into a cavity in a lower die of a compression resin sealing and molding die, which includes upper and lower dies. Then, an electronic component on a substrate is immersed in the liquid resin material. Heat of a prescribed temperature and clamping pressure are applied to the liquid resin material, to seal and mold the electronic component with the resin.

In this method, a dispenser is usually used to supply the liquid thermosetting resin material into the cavity in the lower die. The dispenser is provided, for example, in such a manner that its body can advance into and retract from space between the upper and lower dies. When the upper and lower dies are opened, the dispenser body advances into the space between the upper and lower dies, and then discharges the liquid thermosetting resin material in a required amount from a tip nozzle of the dispenser (see Japanese Patent Laying-Open No. 2003-165133, for example).

### PRIOR ART DOCUMENTS

### Patent Documents

Patent Document 1: Japanese Patent Laying-Open No. 2003-165133 (page, 4, col. 5, lines 7 to 14, FIGS. 9, 11 and the like)

### SUMMARY OF THE INVENTION

### Problems to be Solved by the Invention

The above method of using a liquid thermosetting resin material as a material for sealing and molding an electronic component with resin has the following drawback when sealing and molding a light-emitting diode (LED chip) mounted on a substrate with a silicone resin, for example. The drawback is that since the resin material is cured in a short time, the steps performed after the step of supplying the thermosetting resin material into the lower die cavity cannot be appropriately performed. More specifically, the drawback is that the step of immersing the light-emitting diode on the substrate in the resin material cannot be performed efficiently and under proper conditions.

If the step of supplying the thermosetting resin material into the lower die cavity is not quickly and properly performed, thermosetting reaction of the resin material is facilitated, causing the resin material to have high viscosity. Thus, the resin material is not uniformly supplied to every corner in the lower die cavity. In addition, when the light-emitting diode is immersed in the thermosetting resin material having high viscosity, a gold wire of the diode is deformed or cut. This results in a serious drawback in that resin sealing and molding is performed in an electrically disconnected state.

Further, use of a thermosetting resin material as a resin material involves the following inherent drawback. When a thermosetting resin is used, a resin-molded component immediately after being molded in the lower die cavity has been heated to a resin molding temperature. Thus, the resin-molded component is at a high temperature and still has insufficient hardness. When the resin-molded component in such state is removed from the lower die cavity, the resin-molded component is warped or deformed, resulting in formation of a defective molded component. To avoid this, the resin-molded component is removed from the lower die cavity after the temperature of the resin-molded component is decreased. This step of removing the resin-molded component takes a long time, however, resulting in a prolonged cycle time of overall resin molding. This leads to lowered productivity.

When a large compression resin sealing and molding apparatus in which a plurality of cavity portions are provided in a lower die and a substrate is set in each of these cavity portions, a liquid thermosetting resin material is supplied into each of the cavities. In this case, the thermosetting resin materials in the respective cavities when the steps of supplying all the resin materials are completed have different viscosities. Thus, light-emitting diodes as exemplary electronic components cannot be immersed in the respective liquid thermosetting resin materials under equal conditions. As a result, gold wires of the light-emitting diodes immersed in the resin materials are deformed or cut, as described above. Therefore, again in this case, a compression resin-sealed and molded electronic component having high quality and high reliability cannot be formed efficiently and reliably.

When the large compression resin sealing and molding apparatus is used, by simultaneously supplying the liquid thermosetting resin material into the respective cavities, for example, the liquid thermosetting resin materials in the respective cavities can have the same viscosity. This involves the need to increase the number of provided dispensers described above and the like, however, resulting in a more complicated structure of the overall apparatus, or further size increase in overall shape.

The present invention was made to solve the problems discussed above, and an object of the present invention is to provide a method capable of compression sealing and molding a molded electronic component having high quality and high reliability efficiently and reliably, and an apparatus using this method. Another object of the present invention is to reduce size and weight of the compression resin sealing and molding apparatus through improvement in overall structure of the apparatus. A further object of the present invention is to provide a method and an apparatus capable of efficient compression resin sealing and molding even with use of a liquid thermosetting resin material which tends to be readily cured during resin molding.

### Means for Solving the Problems

A compression resin sealing and molding method for an electronic component according to one aspect of the present invention is a method for immersing an electronic component mounted on a substrate in a liquid resin material in a cavity of a lower die, and applying predetermined heat and pressure to the liquid resin material to seal and mold the electronic component with compression resin. This method includes the steps of supplying the liquid resin material from a gate nozzle in an upper die provided opposite to the lower die into the cavity, and sealing and molding the electronic component on the substrate with compression resin by closing the upper die and the lower die. In the supplying step and the molding step, a temperature of the liquid resin material flowing through the gate nozzle and temperatures of the upper die and the lower die are controlled.

A compression resin sealing and molding apparatus for an electronic component according one aspect of the present invention is an apparatus for immersing an electronic component mounted on a substrate in a liquid resin material in a cavity, and applying predetermined heat and pressure to the liquid resin material to seal and mold the electronic component with compression resin. The apparatus includes an upper die and a lower die arranged opposite to each other in a vertical direction, a gate nozzle for supplying the liquid resin material arranged in the upper die, and a cavity for setting a single substrate, arranged in the lower die and being supplied with the liquid resin material from the gate nozzle. The apparatus also includes a mechanism for controlling a temperature of the liquid resin material flowing through the gate nozzle, and a mechanism for controlling a temperature of each of the upper die and the lower die.

A compression molding method for an electronic component according to another aspect of the present invention uses an apparatus in which a cavity for setting a single substrate is provided in a lower die for resin sealing and molding, and a gate nozzle for supplying a liquid resin material is arranged in an upper die provided opposite to the lower die. This method is a method for immersing an electronic component mounted on the substrate in a liquid resin material supplied into the cavity, and applying predetermined heat and pressure to the liquid resin material to seal and mold the electronic component with compression resin. The method includes the steps of cooling the upper die and the lower die, with a gap for air heat insulation being present between the upper die and an upper die heating heater and between the lower die and a lower die heating heater, cooling the gate nozzle, separating the upper die and the lower die from each other, heating the lower die with heat from the lower die heating heater to a resin molding temperature by eliminating the gap for air heat insulation between the lower die and the lower die heating heater, supplying the liquid resin material into the cavity through the gate nozzle, setting the substrate having the electronic component mounted thereon in a predetermined position of a molding surface of the upper die, heating the upper die with heat from the upper die heating heater to the resin molding temperature by eliminating the gap for air heat insulation between the upper die and the upper die heating heater, a first clamping step of hermetically sealing at least space within the cavity between the upper die and the lower die with a sealing member by contacting the upper die with the lower die, decompressing the space hermetically sealed with the sealing member, a second clamping step of contacting the substrate set on the upper die with a molding surface of peripheral portion of the cavity, and a third clamping step of compressing the liquid resin material in the cavity. The second clamping step and/or the third clamping step includes the step of immersing the electronic component in the liquid resin material in the cavity. The third clamping step includes the step of sealing and molding the electronic component with compression resin. The method further includes the step of forming the gap for air heat insulation between the upper die and the upper die heating heater and between the lower die and the lower die heating heater. The step of forming the gap includes the step of cooling the upper die and the lower die. The method further includes the steps of opening the upper die and the lower die, and removing the sealed and molded electronic component with compression resin from within the cavity to the outside.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an overall structure of a compression resin sealing and molding apparatus for an electronic component according to an embodiment.

FIG. 2 is a partially cutaway front view of the molding apparatus shown in FIG. 1.

FIG. 3 is a partially cutaway enlarged front view of the molding apparatus shown in FIG. 1.

FIG. 4A shows an upper die plate in the molding apparatus shown in FIG. 1, and is a schematic central cross-sectional view of an upper die and a gate nozzle unit.

FIG. 4B is a schematic lower surface view of the upper die plate portion.

FIG. 5A is a schematic central cross-sectional view corresponding to FIG. 4A, illustrating an enlarged gate nozzle unit and its cooling action.

FIG. 5B is a first exploded view of the gate nozzle.

FIG. 5C is a second exploded view of the gate nozzle.

FIG. 5D is a third exploded view of the gate nozzle.

FIG. 6A is a schematic central cross-sectional view corresponding to FIG. 4A, illustrating decompression action when the upper and lower dies are clamped to each other.

FIG. 6B is a schematic central cross-sectional view corresponding to FIG. 4A, illustrating action of adsorbing a substrate to the upper die.

FIG. 7A is a schematic plan view of a lower die plate portion in the molding apparatus shown in FIG. 1.

FIG. 7B is a schematic central cross-sectional view of the lower die plate and the lower die portion.

FIG. 8A is a schematic central cross-sectional view corresponding to FIG. 7B, illustrating cooling action in the lower die.

FIG. 8B is a schematic central cross-sectional view corresponding to FIG. 7B, illustrating decompression action in the lower die.

FIG. 9 is a schematic central cross-sectional view showing the upper die plate and lower die plate portions in the molding apparatus shown in FIG. 1, showing a state where the upper and lower dies are opened, and illustrating a step of supplying a mold release film between the upper and lower dies.

FIG. 10A is a schematic central cross-sectional view corresponding to FIG. 9, illustrating a step of mounting the mold release film on a lower die cavity surface.

FIG. 10B is a schematic central cross-sectional view corresponding to FIG. 9, and is an enlarged view of a substantial portion in FIG. 10A.

FIG. 11A is a schematic central cross-sectional view corresponding to FIG. 9, illustrating a state where the mold release film is adsorbed by a mold release film mounting member.

FIG. 11B is a schematic central cross-sectional view corresponding to FIG. 9, and is an enlarged view of a substantial portion in FIG. 11A.

FIG. 12A is a schematic central cross-sectional view corresponding to FIG. 9, illustrating a state where compressed air is blown by the mold release film mounting member.

FIG. 12B is a schematic central cross-sectional view corresponding to FIG. 9, and is an enlarged view of a substantial portion in FIG. 12A.

FIG. 13A is a schematic central cross-sectional view corresponding to FIG. 9, illustrating a step of supplying a liquid resin material to the lower die cavity surface.

FIG. 13B is a schematic central cross-sectional view corresponding to FIG. 9, and is an enlarged view of a substantial portion in FIG. 13A.

FIG. 14 is a schematic central cross-sectional view corresponding to FIG. 9, illustrating a step of mounting a substrate on an upper die surface.

FIG. 15A is a schematic central cross-sectional view corresponding to FIG. 9, illustrating a first clamped state where hermetically sealed space shut off from outside air is formed between the upper and lower dies by contacting the upper and lower dies with each other.

FIG. 15B is a schematic central cross-sectional view corresponding to FIG. 9, and is an enlarged view of a substantial portion in FIG. 15A.

FIG. 16A is a schematic central cross-sectional view corresponding to FIG. 9, illustrating a second clamped state where the substrate set on the upper die is contacted with the lower die surface.

FIG. 16B is a schematic central cross-sectional view corresponding to FIG. 9, and is an enlarged view of a substantial portion in FIG. 16A.

FIG. 17A is a schematic central cross-sectional view corresponding to FIG. 9, illustrating a third clamped state where a liquid resin material in a lower die cavity is compressed.

FIG. 17B is a schematic central cross-sectional view corresponding to FIG. 9, and is an enlarged view of a substantial portion in FIG. 17A.

FIG. 18A is a schematic central cross-sectional view corresponding to FIG. 9, illustrating a first die-opening step where a gap is present between the upper die and an upper die heating heater, and between the lower die and a lower die heating heater.

FIG. 18B is a schematic central cross-sectional view corresponding to FIG. 9, and is an enlarged view of a substantial portion in FIG. 18A.

FIG. 18C is a schematic central cross-sectional view corresponding to FIG. 9, illustrating mold release action of a substrate.

FIG. 19 is a schematic central cross-sectional view corresponding to FIG. 9, illustrating a step of removing a compression resin-molded component.

FIG. 20 is a schematic central cross-sectional view corresponding to FIG. 9, illustrating the step of removing the compression resin-molded component and its subsequent step of supplying a mold release film.

FIG. 21A is a front view showing a substantial portion of the molding apparatus shown in FIG. 2, showing another embodiment of the mold release film mounting member, a substrate mounting member, and a molded-component removing member.

FIG. 21B is a front view showing a substantial portion of the molding apparatus shown in FIG. 2, and is an enlarged view of a substantial portion in FIG. 21A.

### MODES FOR CARRYING OUT THE INVENTION

A compression resin sealing and molding apparatus according to an embodiment of the present invention will be described with reference to the drawings.

### First Embodiment

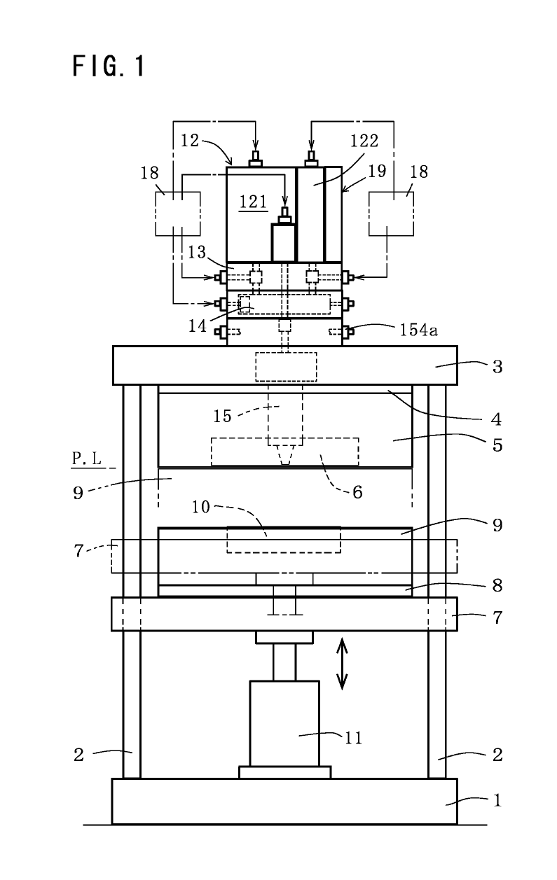

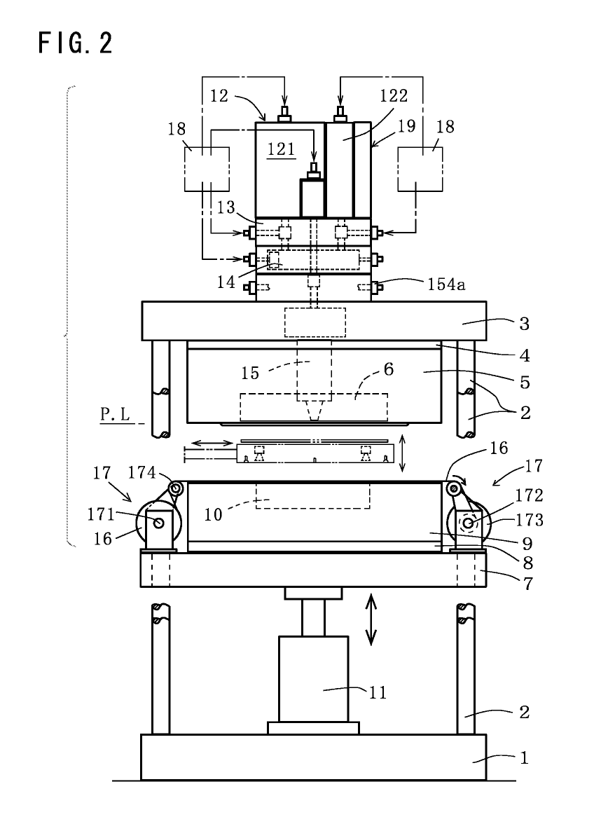

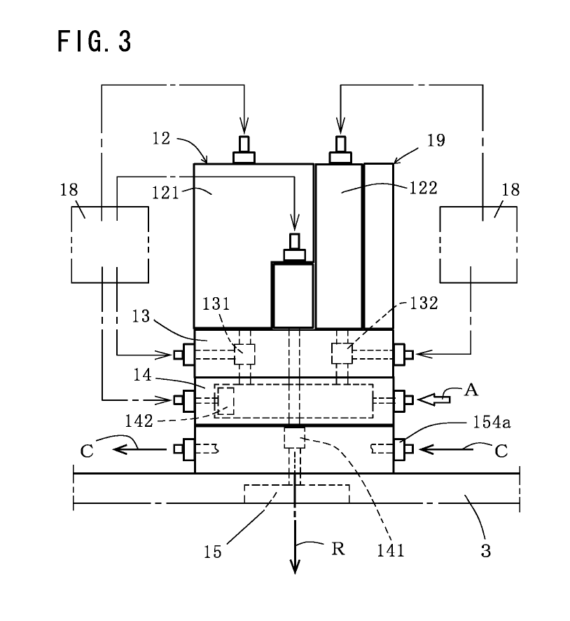

FIGS. 1 to 3 generally show a compression resin sealing and molding apparatus for an electronic component of the present invention. FIGS. 1 and 2 are schematic views of its overall structure, and FIG. 3 shows an enlarged portion thereof.

The compression resin sealing and molding apparatus shown in FIG. 1 includes a base 1 of the apparatus, tie-bars 2 provided to stand on four corners on base 1, and a fixed plate 3 provided on upper end portions of tie-bars 2. In the apparatus, an upper die heat insulation plate 4 is provided on a lower part of fixed plate 3. An upper die plate 5 is mounted on a lower side of upper die heat insulation plate 4. An upper die 6 for compression resin sealing and molding is provided in upper die plate 5. The apparatus also includes a movable plate 7 into which tie-bars 2 are inserted below upper die 6, a lower die plate 9 mounted above movable plate 7 with a lower die heat insulation plate 8 interposed therebetween, and a lower die 10 for compression resin sealing and molding provided in lower die plate 9. In addition, the apparatus includes a die opening/closing mechanism 11 for contacting opposing surfaces of upper and lower dies 6 and 10 with each other or separating them from each other by moving movable plate 7 provided above base 1 upward or downward in a vertical direction. Die opening/closing mechanism 11 is driven by a servomotor or the like. The apparatus also includes, above fixed plate 3, a containing unit 12 for a liquid resin material (e.g., a silicone resin and a curing agent), a measuring unit 13 for the liquid resin material, and a mixing and transferring unit 14 for the liquid resin material. The apparatus further includes a gate nozzle 15 provided in upper die plate 5 for supplying the liquid resin material in a required amount transferred from mixing and transferring unit 14 for the liquid resin material to a required portion in lower die 10 (into a lower die cavity).

Further, as will be described later, upper die plate 5 and lower die plate 9 each include a heater each for heating upper die 6 and lower die 10. In addition, upper and lower dies 6, 10 and gate nozzle 15 provided in upper die plate 5 and lower die plate 9 each include dedicated cooling means. Accordingly, these elements function as temperature control means for upper and lower dies 6, 10 and temperature control means for gate nozzle 15.

As shown in FIG. 2, on an upper surface portion of movable plate 7, a mold release film setting mechanism 17 for bringing a molded component release film 16 under tension into contact with a surface (molding surface) of lower die 10 including at least a lower die cavity surface is provided. Mold release film setting mechanism 17 includes a mold release film supply roller 171 arranged on one side of the upper surface portion of movable plate 7, and a mold release film winding roller 172 arranged on the other side of the upper surface portion of movable plate 7. Mold release film setting mechanism 17 also includes a motor 173 for rotating and driving the winding roller, and a tension roller 174 for providing appropriate tension to mold release film 16 set between rollers 171 and 172 so that mold release film 16 will not be wrinkled or slacked.

As will be described later, lower die 10 includes a single resin molding cavity in which a small substrate, e.g., one square substrate about 50 mm to 70 mm per side is to be set. Thus, the lower die has been reduced in size. Along with such size reduction of the die, structures of its corresponding components have also been reduced in size. Accordingly, the entire apparatus has been reduced in size. Therefore, the present apparatus is constituted as a so-called desktop compression resin sealing and molding apparatus.

Next, relation among containing unit 12, measuring unit 13 and mixing and transferring unit 14 for the liquid resin material is described in detail.

As shown in an enlarged manner in FIG. 3, containing unit 12 includes a containing tank 121 for the liquid resin material such as a silicone resin serving as a main agent, and a containing tank 122 for a liquid curing agent.

Measuring unit 13 includes an opening/closing valve 131 and an opening/closing valve 132 which are opened/closed in response to a signal from a control unit 18. Opening/closing valve 131 is set to be opened in response to an opening signal from control unit 18, and to be closed after the liquid resin material in a required amount in containing tank 121 is injected into mixing and transferring unit 14. Opening/closing valve 132 is set to be opened in response to an opening signal from control unit 18, and to be closed after the liquid curing agent in a required amount in containing tank 122 is injected into mixing and transferring unit 14.

In mixing and transferring unit 14, the liquid resin material and the liquid curing agent injected through opening/closing valves 131, 132, respectively, are mixed with each other uniformly. Mixing and transferring unit 14 includes an opening/closing valve 141 which is opened/closed in response to a signal from control unit 18. When opening/closing valve 141 is opened, the liquids mixed with each other in mixing and transferring unit 14 (liquid thermosetting resin material R) is smoothly transferred to gate nozzle 15 below.

A reference numeral 19 indicates an operation panel unit of the apparatus.

As means for mixing the liquids injected into mixing and transferring unit 14 with each other, a mixing mechanism such as a rotating impeller blade 142 for mixing the liquids with each other thorough stirring may be employed. However, any other mixing mechanism than rotating impeller blade 142 may be used as long as the mechanism has a structure capable of mixing the liquid resin material and the liquid curing agent with each other as needed and sufficiently in a transfer path from measuring unit 13 through gate nozzle 15.

A reference sign A in FIG. 3 indicates compressed air. Compressed air A is introduced into mixing and transferring unit 14 upon completion of transfer of the liquids described above, to transfer the total amount of the mixed liquids to gate nozzle 15 more reliably. This step of transferring the liquids with compressed air (i.e., step of transferring the remaining liquid thermosetting resin material) is a step for helping with the action of transferring the liquids to gate nozzle 15, and thus may be employed as necessary and is not a required step. In order to help with the transferring action, compressed air may be introduced into measuring unit 13 to transfer part of the liquid resin material remaining in this measuring unit toward gate nozzle 15 (into mixing and transferring unit 14).

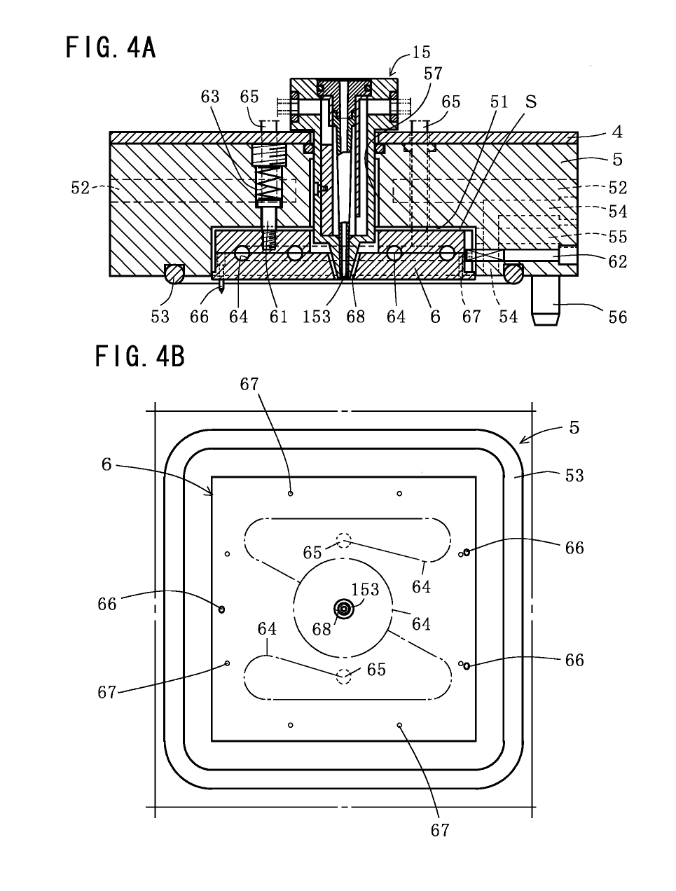

FIGS. 4A to 6B illustrate relation between upper die plate 5, upper die 6 and gate nozzle 15. The relation is described in detail below.

FIG. 4A shows a portion including upper die plate 5, upper die 6 and gate nozzle 15. FIG. 4B shows a bottom surface (lower surface) of the portion.

Upper die 6 is fitted in a recess 51 provided in a lower surface of upper die plate 5, and may be readily removed from recess 51. Upper die 6 is fixed within recess 51 by a fixing pin 61, and positioned in a predetermined position within upper die plate 5 by a positioning pin 62. A resilient projection force is applied to upper die 6 by a resilient member 63 for pushing fixing pin 61 downward. The upper die is thus biased to be separated downward from an inner surface of recess 51. In other words, a so-called floating structure is formed. Under normal conditions, therefore, a gap S of about 1 mm is present between upper die 6 and the inner surface of recess 51.

Upper die plate 5 includes therein a cartridge heater 52 for heating the upper die. Thus, upper die plate 5 may be heated by cartridge heater 52. Under normal conditions, however, gap S described above is present and thus has air heat insulation action between upper die 6 and recess 51. Accordingly, heating action on upper die 6 is efficiently suppressed.

Upper die 6 includes therein a coolant path 64 for cooling the upper die. Coolant path 64 is connected to an introduction and discharge pipe 65 for a coolant, which is connected to a water supply and discharge pump (not shown). Thus, when upper die 6 is cooled, a coolant can be introduced into coolant path 64 through introduction and discharge pipe 65 by actuating the water supply and discharge pump. Conversely, when upper die 6 is heated, the coolant in coolant path 64 can be discharged to the outside of upper die 6 through introduction and discharge pipe 65.

A reference numeral 66 indicates a pilot pin provided to project from a lower surface of upper die 6.

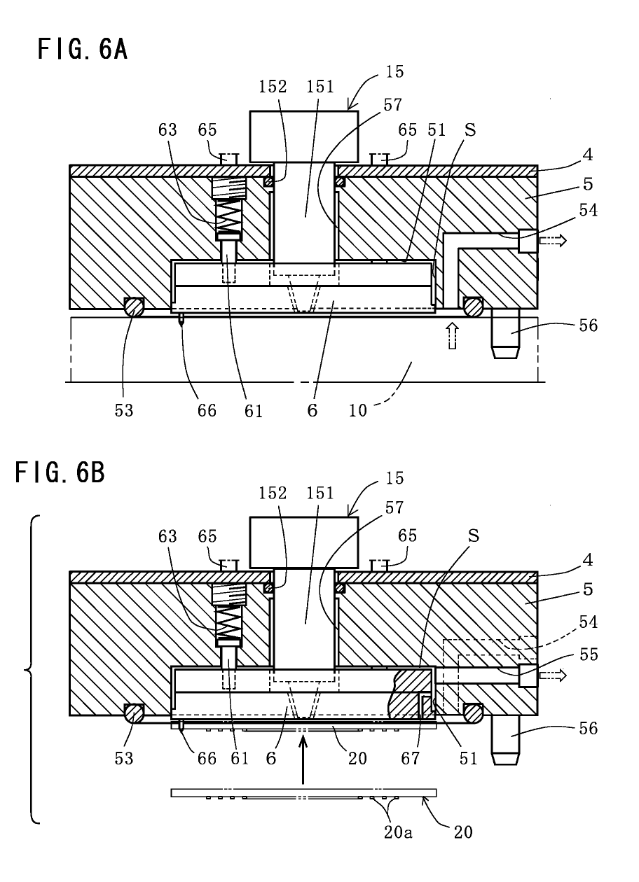

A reference numeral 67 indicates an air intake hole having an opening in the lower surface of upper die 6. As shown in FIG. 6B, air intake hole 67 is provided to be in communication with space within recess 51.

To efficiently and quickly heat and cool upper die 6, it is preferable that upper die 6 be made of a copper-based material having high thermal conductivity.

A sealing member 53 for shutting off outside air is disposed in the lower surface of upper die plate 5. When upper and lower dies 6, 10 are clamped to each other and their molding surfaces are contacted with each other as will be described later, sealing member 53 seals a gap between the molding surfaces of upper and lower dies 6, 10 (see FIG. 6A).

Upper die plate 5 includes an air intake pathway 54 for bringing space hermetically sealed by sealing member 53 in communication with outside space. The space hermetically sealed by sealing member 53 is decompressed through air intake pathway 54.

Upper die plate 5 also includes an air intake pathway 55 for bringing the space within recess 51 (gap S) in communication with the outside space (see FIG. 6B). In addition, air intake pathway 55 is in communication with an externally arranged vacuum motor (not shown). Thus, the space within recess 51 (gap S) can be decompressed by actuating the vacuum motor.

Under normal conditions, as described above, gap S is present between upper die 6 and recess 51 of upper die plate 5. When the space within recess 51 (gap S) is decompressed by the vacuum motor (not shown), upper die 6 fitted in recess 51 moves upward against the downward resilient projection force of resilient member 63, and is then contacted with the inner surface of recess 51. Accordingly, a mechanism for contacting upper die 6 with the inner surface of recess 51 in upper die plate 5 forms an upper die heating mechanism for providing heat from cartridge heater 52 for heating the upper die provided in upper die plate 5 to upper die 6.

A reference numeral 56 indicates an upper die guide pin.

As described above, gate nozzle 15 provided in upper die plate 5 is used to quickly supply the liquid resin material in a required amount transferred from mixing and transferring unit 14 for the liquid resin material into the lower die cavity. Gate nozzle 15 is provided in a manner readily attachable/detachable with respect to upper die heat insulation plate 4 and a removably fit unit 57 in a vertical direction provided in a central portion of upper die plate 5.

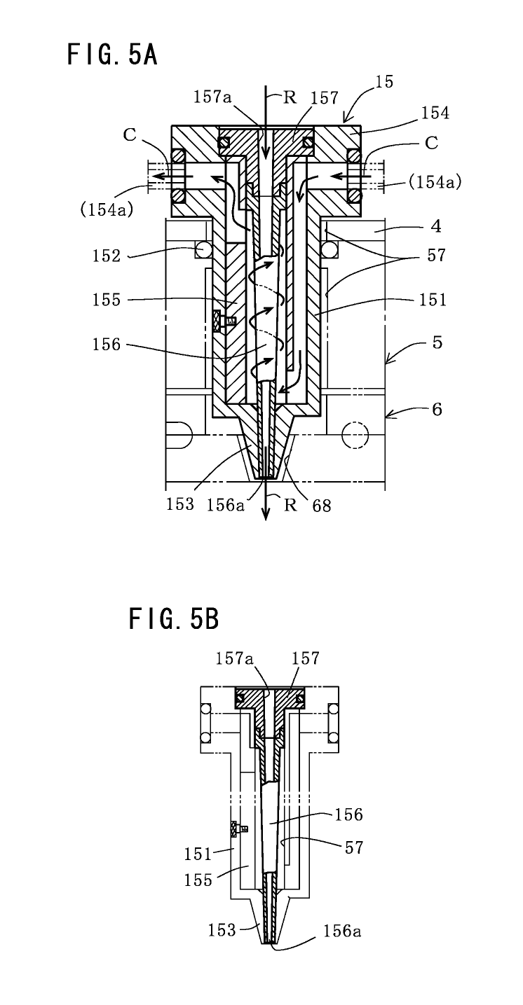

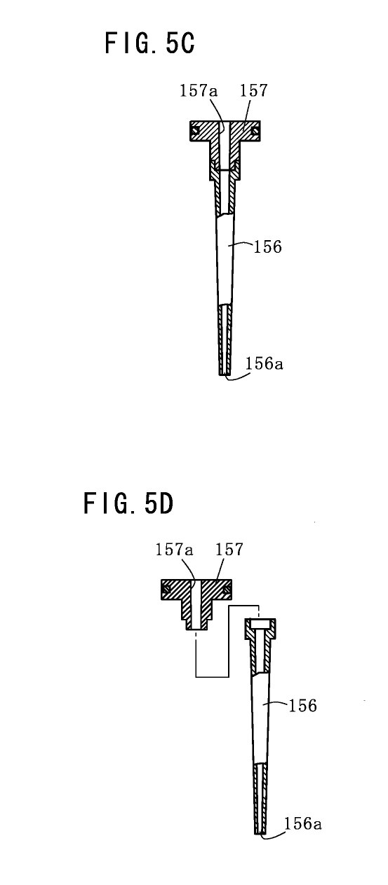

Namely, as shown in FIG. 5A, a gate nozzle body 151 is fitted in upper die heat insulation plate 4 and removably fit unit 57 in a vertical direction provided in the central portion of upper die plate 5, with a sealing member 152 interposed therebetween. A lower end nozzle unit 153 of gate nozzle body 151 is fitted in an opening 68 in a vertical direction formed in a central portion of upper die 6, and is provided not to project downward from the lower surface of upper die 6.

A coolant introduction and discharge unit 154 on an upper end portion of gate nozzle body 151 described above is provided to project from an upper surface portion of upper die heat insulation plate 4. Coolant introduction and discharge unit 154 is connected to a coolant pipe 154a.

A sleeve-like coolant path member 155 for distributing and circulating a coolant is fitted in gate nozzle body 151 while being in close contact with and integrated into an inner surface of gate nozzle body 151.

A nozzle chip 156 for discharging the liquid resin material is inserted in a central portion of coolant path member 155 in a readily attachable/detachable manner. Nozzle chip 156 is formed to have a shape tapered downward. In addition, nozzle chip 156 is made of a water-repellent material for preventing clogging due to adhesion of the liquid resin material flowing through nozzle chip 156 to an inner surface of nozzle chip 156 and the like.

A holding member 157 for reliably holding nozzle chip 156 in coolant path member 155 is fixed on an upper end portion of nozzle chip 156 in a readily attachable/detachable manner. When nozzle chip 156 is held in coolant path member 155 by holding member 157, holding member 157 is connected to nozzle chip 156 such that a communication hole 157a formed in a central portion of the holding member is in communication with a liquid resin material discharge hole 156a in the nozzle chip. When liquid resin material R is transferred into communication hole 157a in the holding member, liquid resin material R is smoothly guided to liquid resin material discharge hole 156a in nozzle chip 156, and then immediately discharged below from liquid resin material discharge hole 156a. A lower end portion of nozzle chip 156 held in coolant path member 155 is fitted in close contact with an inner surface of nozzle unit 153 of the gate nozzle body, and is provided not to project downward from nozzle unit 153.

In addition, gate nozzle 15 is provided in a manner readily attachable/detachable with respect to removably fit unit 57, and nozzle chip 156 and holding member 157 are provided in a manner readily attachable/detachable with respect to coolant path member 155, as shown in FIGS. 5B to 5D.

By providing gate nozzle 15 in this manner that it can be disassembled and readily attached/detached, for example, nozzle chip 156 can be employed depending on properties of a resin material used before resin molding operation, and nozzle chip 156 and the like can be efficiently cleaned and changed after resin molding operation. In particular, when a thermosetting resin material is used, it is preferable that, in case of a malfunction such as when nozzle chip 156 and the like cannot be used due to adhesion of a portion of the resin material to inner surfaces and the like of liquid resin material discharge hole 156a and communication hole 157a and curing of the portion, quick response such as cleaning or change of nozzle chip 156 can be taken.

As shown in FIG. 6A, when upper and lower dies 6, 10 are clamped to each other, the space hermetically sealed by sealing member 53 (space shut off from outside air) is in communication with the externally arranged vacuum motor (not shown) through air intake pathway 54, as described above. Thus, the space hermetically sealed by sealing member 53 can be decompressed by actuating the vacuum motor.

As shown in FIG. 6B, air intake hole 67 having the opening in the lower surface of upper die 6 and the space within recess 51 (gap S) of upper die plate 5 are in communication with the externally arranged vacuum motor (not shown) through air intake pathway 55, as described above. Thus, the space within air intake hole 67, the space within recess 51 (gap S) in the upper die plate, and the space within air intake pathway 55 can be decompressed by actuating the vacuum motor. Accordingly, as will be described later, a square substrate 20 can be set on the lower surface of upper die 6 through adsorption action of air intake hole 67 based on this decompression. Here, square substrate 20 is positioned by pilot pin 66 projecting from the lower surface of upper die 6, and so square substrate 20 is reliably mounted in a predetermined position of the lower surface of upper die 6 through the adsorption action and the positioning action.

The adsorption action on square substrate 20 and the decompression action on the space hermetically sealed by sealing member 53 may be separately and independently performed.

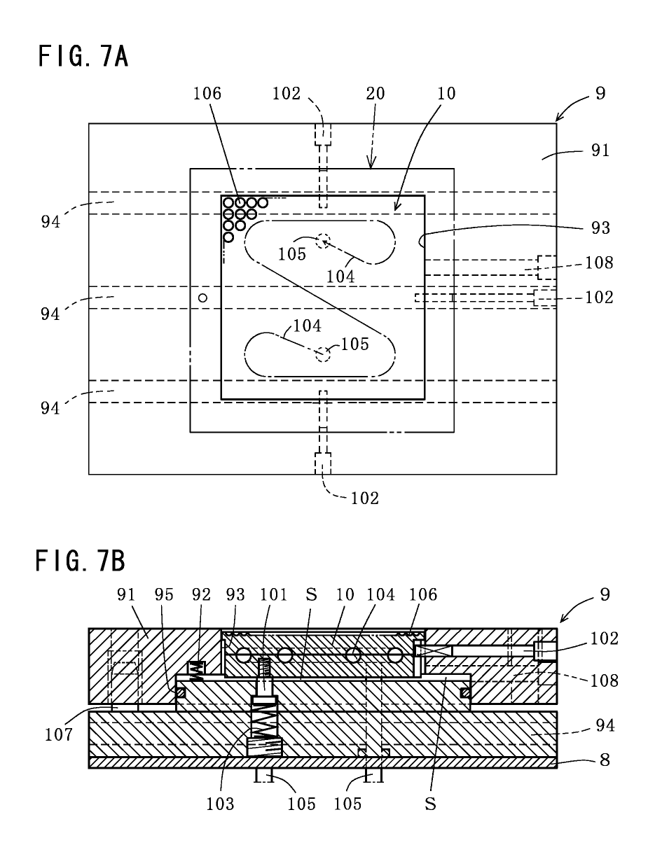

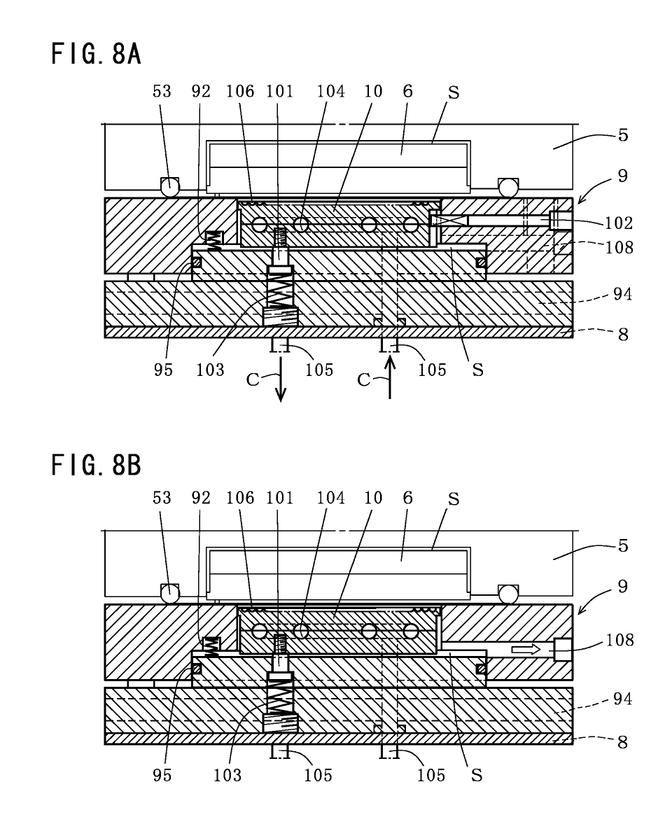

Next, a portion including lower die plate 9 and lower die 10 shown in FIGS. 7A, 7B, 8A, and 8B is described in detail.

FIG. 7A shows an upper surface of the portion including lower die plate 9 and lower die 10, and FIG. 7B is a schematic central cross-sectional view of the portion including lower die plate 9 and lower die 10.

A floating plate 91 is provided in an upper surface portion of lower die plate 9. A resilient member 92 is interposed between lower die plate 9 and floating plate 91, and a resilient force of resilient member 92 acts to separate lower die plate 9 and floating plate 91 from each other in a vertical direction.

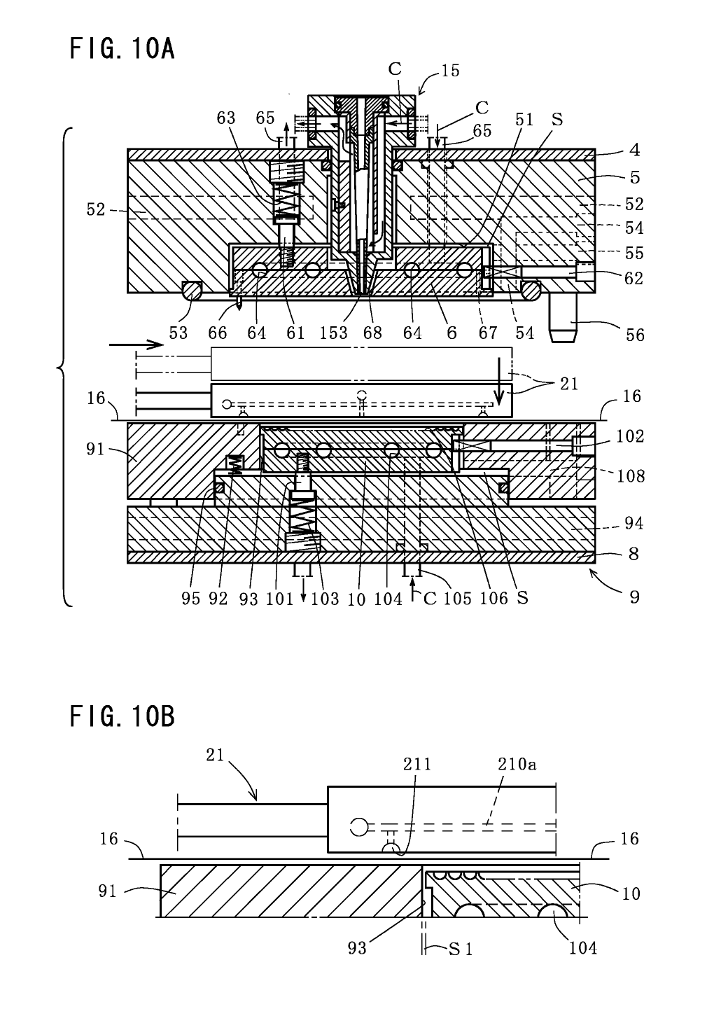

Lower die 10 is fitted in the upper surface portion of lower die plate 9. Lower die 10 is fitted in an attachment hole portion 93 provided in a central portion of floating plate 91 in a manner slidable in a vertical direction, with an air intake gap S1 being formed between an outer peripheral surface of lower die 10 and an inner peripheral surface of attachment hole portion 93 (see FIG. 10B). Further, lower die 10 is fixed in attachment hole portion 93 by a fixing pin 101, and positioned in a predetermined position within attachment hole portion 93 by a positioning pin 102. A resilient projection force pushing fixing pin 101 upward is applied to lower die 10 by resilience of a resilient member 103. Thus, a so-called floating structure in which lower die 10 is biased to be separated from the upper surface of lower die plate 9 is formed. Under normal conditions, therefore, gap S of about 1 mm is present between lower die 10 and the upper surface of lower die plate 9.

Lower die plate 9 includes therein a cartridge heater 94 for heating lower die 10. Under normal conditions, gap S is present between lower die 10 and the upper surface of lower die plate 9 and thus has air heat insulation action, thereby efficiently suppressing heating action on lower die 10.

Lower die 10 includes therein a coolant path 104 for cooling, and coolant path 104 is connected to an introduction and discharge pipe 105 for a coolant, which is in communication with the water supply and discharge pump (not shown). Thus, when lower die 10 is cooled, a coolant can be introduced into coolant path 104 in lower die 10 through introduction and discharge pipe 105 by actuating the water supply and discharge pump. Conversely, when lower die 10 is heated, the coolant in lower die coolant path 104 can be discharged to the outside of lower die 10 through introduction and discharge pipe 105.

A reference numeral 106 indicates the lower die cavity having a shape corresponding to a shape of a component for sealing and molding electronic component 20a mounted on square substrate 20, which is space formed by a resin molding surface in lower die 10. A reference numeral 107 indicates a lower die guide pin.

To efficiently and quickly heat and cool lower die 10, it is preferable that lower die 10 be made of a copper-based material having high thermal conductivity.

As described above, lower die 10 is fitted in attachment hole portion 93 in floating plate 91 in a manner slidable in a vertical direction. In addition, gap S is present between lower die 10 and the upper surface of lower die plate 9. Further, lower die plate 9 and floating plate 91 are provided with a sealing member 95 interposed therebetween.

Lower die plate 9 also includes an air intake pathway 108 for bringing space within attachment hole portion 93 and gap S in communication with the outside space. Air intake pathway 108 is in communication with the externally arranged vacuum motor (not shown). Thus, the space within attachment hole portion 93 and the space within gap S can be decompressed by actuating the vacuum motor.

Under normal conditions, as described above, gap S is present between lower die 10 and the upper surface of lower die plate 9. When the space within attachment hole portion 93 and the space within gap S are decompressed with the above vacuum motor, lower die 10 fitted in attachment hole portion 93 moves downward against the upward resilient projection force of resilient member 103, and is contacted with the upper surface of lower die plate 9 below. Accordingly, a mechanism for contacting lower die 10 with lower die plate 9 forms a lower die heating mechanism for providing heat from cartridge heater 94 for heating the lower die provided in lower die plate 9 to lower die 10.

Next, a mold release film mounting device for the lower die cavity surface shown in FIGS. 10A to 12B is described in detail.

This mold release film mounting device is provided for the compression resin sealing and molding apparatus for an electronic component. The mold release film mounting device includes a member for mounting a mold release film on the lower die cavity (106) surface, i.e., a mold release film mounting member 21. The device also includes a reciprocating and driving mechanism (not shown) for reciprocating mold release film mounting member 21 such that member 21 can advance into and retract from space between upper die 6 and lower die 10 (can reciprocate in a horizontal direction).

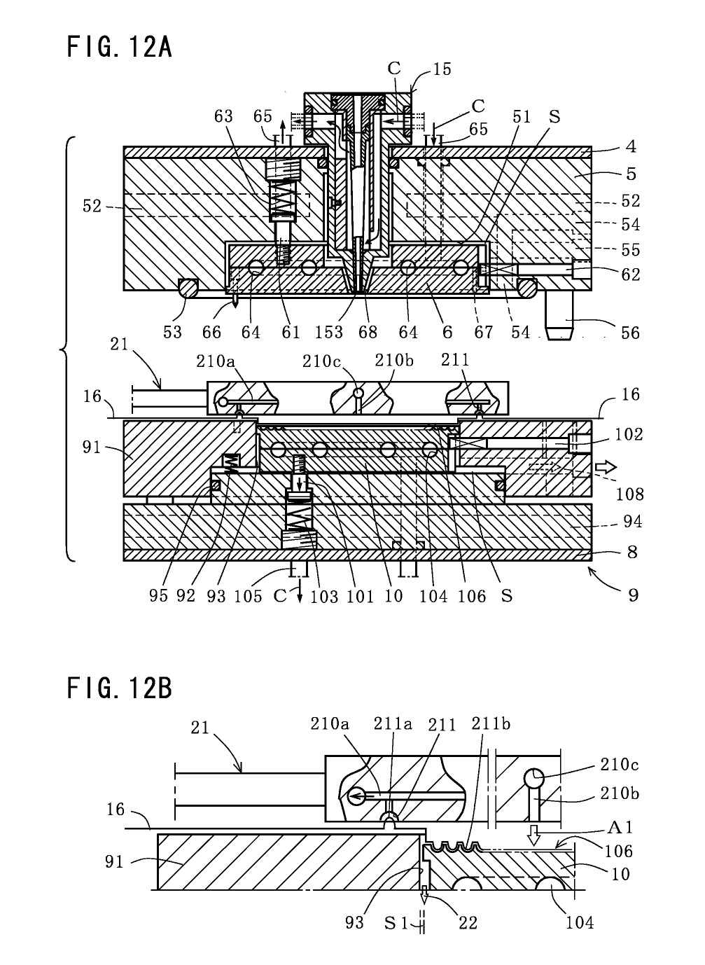

Mold release film mounting member 21 includes a suction hole 211 for forcibly suctioning a peripheral section of mold release film 16 set on the lower die cavity (106) surface, which corresponds to an outer peripheral portion of the lower die cavity portion. Mold release film mounting member 21 also includes an air intake path 210a for bringing suction hole 211 in communication with a vacuum tank (not shown). Mold release film mounting member 21 further includes a compressed air ejection hole 210b for supplying compressed air A1 to mold release film 16 suctioned by suction hole 211 (211a). In addition, mold release film mounting member 21 includes a compressed air supply path 210c for bringing compressed air ejection hole 210b in communication with a compressed air tank (not shown) (see FIG. 12B).

Suction hole 211 is provided on a lower surface side of mold release film mounting member 21, and is arranged on a peripheral section of a virtual circular shape corresponding to the outer peripheral portion of the lower die cavity (106) portion. Compressed air ejection hole 210b is positioned in a central portion of the peripheral section of the virtual circular shape.

A resin sealing and molding method performed with the compression molding apparatus in the above embodiment is described in detail below.

First, referring to FIG. 3, a step of supplying the liquid thermosetting resin material into gate nozzle 15 provided in the upper die plate is described.

Control unit 18 of operation panel unit 19 is operated to open opening/closing valves 131, 132. As a result, the liquid resin material (main agent) and the liquid curing agent in containing tanks 121, 122 are measured and injected into mixing and transferring unit 14 below. Opening/closing valves 131, 132 are then closed (step of measuring the liquid resin material).

Next, the liquid resin material (main agent) and the liquid curing agent injected into mixing and transferring unit 14 are uniformly mixed with each other by an appropriate mixing mechanism such as rotating impeller blade 142. As a result, liquid thermosetting resin material R is produced (step of mixing the liquids with each other).

Next, control unit 18 is operated to open opening/closing valve 141 in mixing and transferring unit 14. As a result, liquid thermosetting resin material R in mixing and transferring unit 14 is smoothly transferred to gate nozzle 15 below (step of transferring the liquid thermosetting resin material). Liquid thermosetting resin material R transferred into gate nozzle 15 flows below, and is immediately supplied into the lower die cavity positioned below gate nozzle 15 (step of supplying the liquid thermosetting resin material).

By introducing compressed air A into mixing and transferring unit 14 upon completion of the step of supplying liquid thermosetting resin material R, as described above, liquid thermosetting resin material R in mixing and transferring unit 14 can be more reliably transferred to gate nozzle 15. Moreover, liquid thermosetting resin material R that tends to remain in mixing and transferring unit 14 can be transferred to gate nozzle 15 (step of transferring the remaining liquid resin material).

Next, a step of resin sealing and molding electronic component 20a mounted on square substrate 20 with liquid thermosetting resin material R transferred into gate nozzle 15 is described.

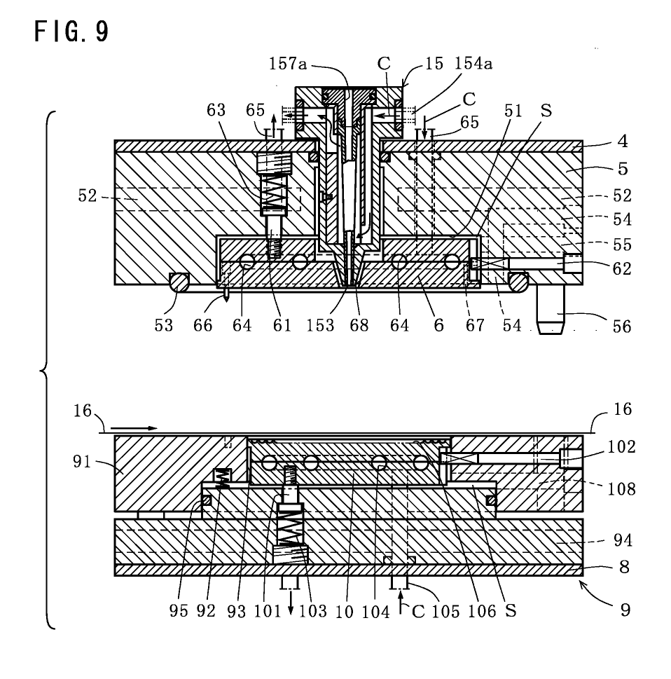

Initially, as shown in FIG. 9, upper die 6, lower die 10, and gate nozzle 15 in the resin sealing and molding apparatus have been cooled by a coolant C introduced into upper die 6, lower die 10, and gate nozzle 15, while upper die plate 5 and lower die plate 9 have been heated to a resin molding temperature by receiving heat from cartridge heaters 52, 94, respectively.

Here, gap S discussed above is present between upper die plate 5 and upper die 6, and between lower die plate 9 and lower die 10, and so heat from cartridge heaters 52, 94 is not positively provided to upper die 6 and lower die 10, respectively, through air heat insulation action of gap S. Thus, heating action on upper and lower dies 6, 10 is efficiently suppressed.

Liquid thermosetting resin material R is transferred to gate nozzle 15. Liquid thermosetting resin material R needs to be supplied to the lower die cavity (106) surface below while maintaining its flowability. For this reason, in order to prevent facilitation of thermosetting reaction of liquid thermosetting resin material R due to heat from upper die plate 5, the step of cooling gate nozzle 15 is continued.

In such state, first, movable plate 7 is moved downward. As a result, upper and lower dies 6, 10 are opened as shown in FIG. 9.

After the step of opening the dies, mold release film setting mechanism 17 (see FIG. 2) is actuated to supply mold release film 16 to a surface of lower die 10 including at least the lower die cavity (106) surface (step of supplying the mold release film).

After the step of supplying the mold release film, mold release film 16 is mounted on the surface of lower die 10 (step of mounting the mold release film). In this step of mounting the mold release film, mold release film mounting member 21 is inserted between upper and lower dies 6, 10, as shown in FIG. 10A, and moved down to a position where a lower surface of mold release film mounting member 21 is close to, or is contacted with an upper surface of mold release film 16, as shown in FIG. 10B.

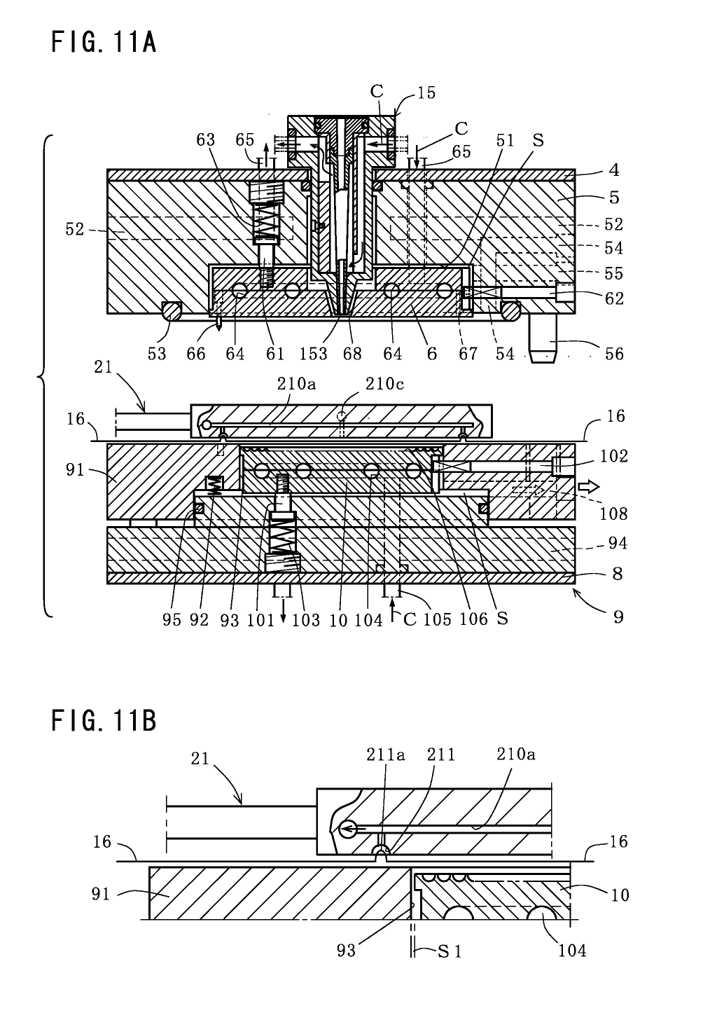

Then, as shown in FIGS. 11A and 11B, a predetermined portion of mold release film 16 set on the surface of lower die 10 is forcibly suctioned (211a) by suction hole 211 provided in the lower surface of mold release film mounting member 21.

As described above, suction hole 211 is arranged on the peripheral section of the virtual circular shape corresponding to the outer peripheral portion of the lower die cavity (106) portion. Accordingly, the lower die cavity peripheral portion of mold release film 16 set on the surface of lower die 10 is supported to the lower surface of mold release film mounting member 21, while being suctioned by suction hole 211 in the lower surface of mold release film mounting member 21.

In such state, as shown in FIGS. 12A and 12B, compressed air A1 is supplied to mold release film 16 supported to the lower surface of mold release film mounting member 21, as indicated with a reference sign 211a. As a result, mold release film 16 is expanded below. Consequently, mold release film 16 can be fitted (211b) to the lower die cavity (106) surface while expanding below (see FIG. 12B).

Compressed air A1 is supplied from compressed air ejection hole 210b positioned in the central portion of the peripheral section of the virtual circular shape described above to a central portion of mold release film 16 supported to the lower surface of mold release film mounting member 21, as indicated with a reference sign 211a. Here, a pressure of compressed air A1 ejected from compressed air ejection hole 210b can be arbitrarily selected. For example, by ejecting compressed air having a small air pressure (small pressure) from compressed air ejection hole 210b, the mold release film can be fitted to the lower die cavity (106) surface along a shape of the lower die cavity (106) surface while gradually expanding below.

In addition, as indicated with a reference sign 211b, fitting of mold release film 16 to the lower die cavity (106) surface is performed together with decompression in a lower die heating step to be described later, for improved efficiency.

After the step of mounting the mold release film, or simultaneously with the step of mounting the mold release film, heat from cartridge heater 94 is provided to lower die 10 to heat lower die 10 to the resin molding temperature (step of heating the lower die).

In this step of heating the lower die, as shown in FIGS. 12A and 12B, the vacuum motor (not shown) is actuated to decompress space within attachment hole portion 93 and space within gap S between lower die 10 and the upper surface of lower die plate 9 through air intake pathway 108. As a result, lower die 10 moves downward against the resilient projection force of resilient member 103, and is contacted with the upper surface of lower die plate 9. Consequently, heat from lower die plate 9, i.e., from cartridge heater 94 is supplied to lower die 10 to increase the temperature of the lower die to the resin molding temperature.

After or simultaneously with the step of heating the lower die, the water supply and discharge pump (not shown) is actuated to forcibly discharge coolant C in lower die coolant path 104 to the outside through introduction and discharge pipe 105 (step of discharging the lower die coolant). Thus, the step of heating the lower die can be more quickly performed.

If the lower die is made of a copper-based material having high thermal conductivity, this step of heating the lower die can be even more quickly performed.

The decompression force for the space within attachment hole portion 93 and the space within gap S described above in the step of heating the lower die also acts as suction force 22 for forcibly suctioning mold release film 16 from gap S1 formed where attachment hole portion 93 is fitted in lower die 10, as shown in FIG. 12B. Accordingly, as indicated with reference sign 211b, fitting of the mold release film to the lower die cavity (106) surface is efficiently performed together with mounting of the mold release film discussed above.

Next, after the step of mounting the mold release film is completed, a step of retracting mold release film mounting member 21 from the space between upper and lower dies 6, 10 to the outside is performed.

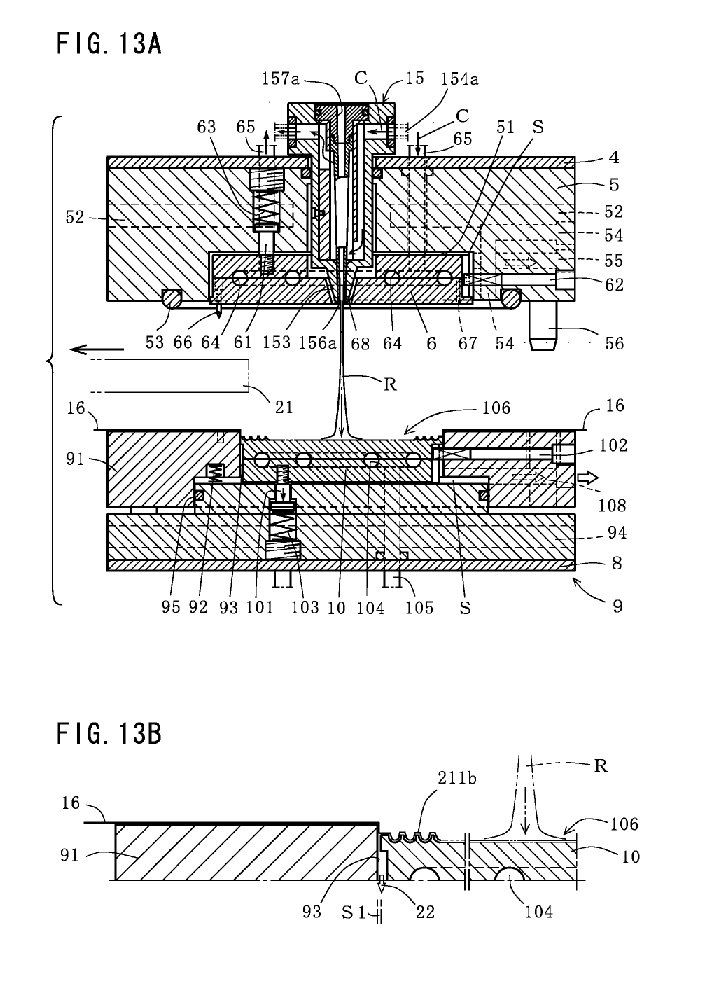

Next, as shown in FIGS. 13A and 13B, a step of supplying liquid thermosetting resin material R through gate nozzle 15 into the lower die cavity (106) on which mold release film 16 has been set is performed (step of supplying the resin material).

In this step of supplying the liquid resin material, as described above, control unit 18 is operated to open opening/closing valve 141 in mixing and transferring unit 14. As a result, liquid thermosetting resin material R in the mixing and transferring unit is transferred to gate nozzle 15 below. Then, liquid thermosetting resin material R is (after smoothly flowing downward through gate nozzle 15) immediately discharged into space within the lower die cavity (106) below, through communication hole 157a in the holding member and liquid resin material discharge hole 156a in the nozzle chip of the gate nozzle. Here, liquid thermosetting resin material R is, after being transferred to upper communication hole 157a and before being discharged from lower discharge hole 156a, forcibly cooled by coolant C flowing and circulating through coolant path member 155 all the time (see FIGS. 5A and 5B). Thus, thermosetting reaction of the liquid thermosetting resin material is efficiently suppressed.

Since thermosetting reaction of liquid thermosetting resin material R is suppressed in this manner, liquid thermosetting resin material R supplied into the space within the lower die cavity (106) maintains its flowability. Therefore, liquid thermosetting resin material R smoothly flows through the space within the lower die cavity (106), and is uniformly supplied to every corner in the space within the lower die cavity (106). Here, while liquid thermosetting resin material R which has been cooled rises in temperature upon receiving heat from heated lower die 10, this temperature rising acts to lower the viscosity of the liquid thermosetting resin material to increase its flowability. As a result, the liquid thermosetting resin material can be advantageously supplied smoothly and uniformly to every corner in the space within the lower die cavity (106).

After the step of supplying the liquid resin material, or simultaneously with the completion of the step of supplying the liquid resin material, space within gate nozzle 15 is decompressed to prevent leakage of liquid thermosetting resin material R remaining in the gate nozzle from nozzle unit 153 (liquid resin material discharge hole 156a) (step of preventing leakage of the liquid resin material).

As described above, liquid thermosetting resin material R transferred into gate nozzle 15 is immediately discharged into the lower die cavity (106) below. Thus, a portion of the liquid thermosetting resin material will not remain in gate nozzle 15.

Therefore, the step of preventing leakage of the liquid resin material may be employed as necessary. For example, when a portion of the liquid thermosetting resin material remains in gate nozzle 15 due to some cause, and drops and cures on the surface (molding surface) of lower die 10, problems occur such as interference with clamping action on the upper and lower dies. In order to avoid such problems, therefore, it is desirable to employ the step of preventing leakage of the liquid resin material.

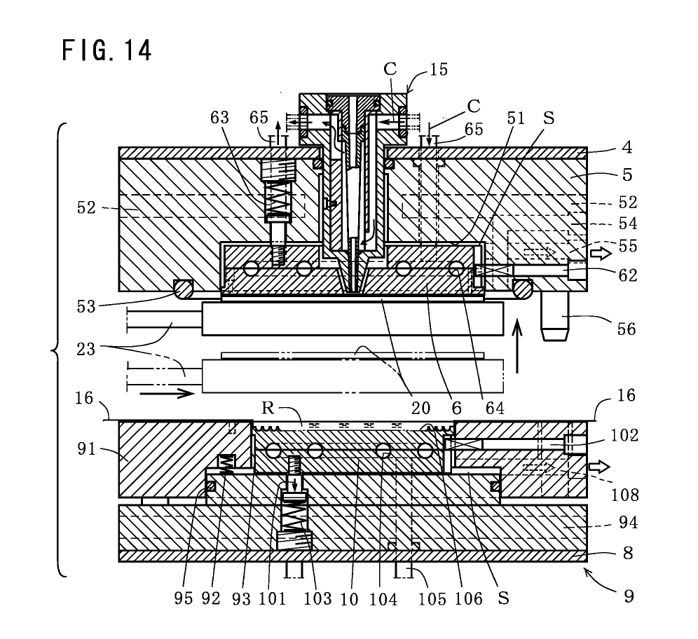

Next, as shown in FIG. 14, a substrate mounting member 23 having square substrate 20 mounted thereon is inserted between upper and lower dies 6, 10 and moved upward, to set the square substrate in a predetermined position on the lower surface of upper die 6 (step of supplying and setting the substrate).

This setting of square substrate 20 onto the lower surface of the upper die is implemented by decompressing the space within recess 51 in upper die plate 5 and the space within air intake hole 67 in upper die 6 in communication therewith (adsorption action through the air intake hole) by actuating the vacuum motor (not shown), as described above (see FIG. 6B). Square substrate 20 is reliably fixed in the predetermined position on the lower surface of upper die 6 by pilot pin 66 projecting from the lower surface of the upper die. Here, square substrate 20 is positioned to have a substrate body suctioned to the lower surface of upper die 6 and to have the surface with electronic component 20a mounted thereon below (downward), as schematically shown in FIG. 6B.

After the step of setting the substrate, or simultaneously with the step of setting the substrate, heat from cartridge heater 52 is provided to upper die 6 to heat the upper die to the resin molding temperature (step of heating the upper die).

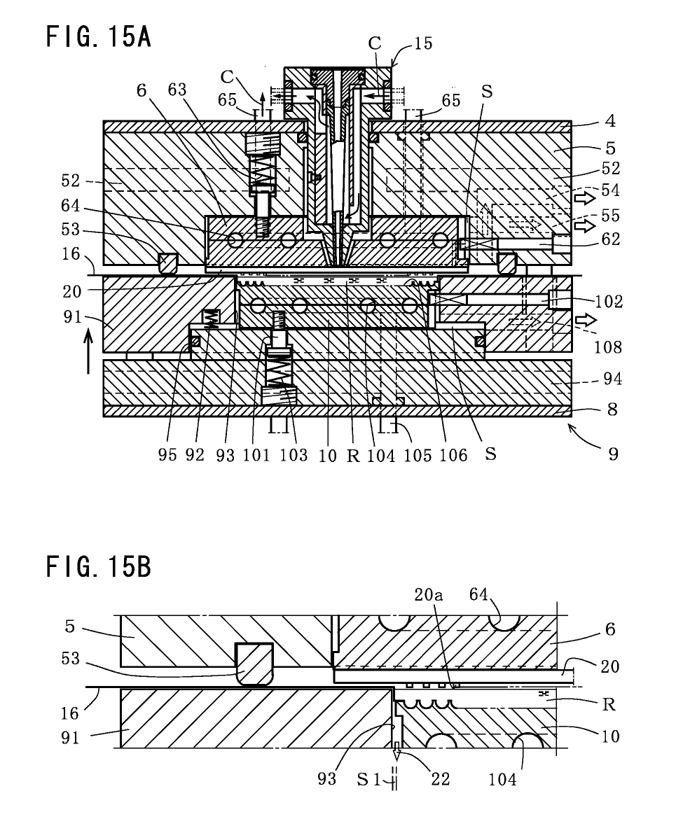

In the step of heating the upper die, the space within gap S between upper die 6 and the inner surface of recess 51 described above is decompressed, causing upper die 6 to move upward against the resilient projection force of resilient member 63, and be contacted with the inner surface of recess 51 in upper die 6, as shown in FIGS. 15A and 15B. As a result, heat from cartridge heater 52 can be provided to upper die 6 to heat the upper die to the resin molding temperature.

After or simultaneously with the step of heating the upper die, the pump (not shown) can be actuated to forcibly discharge coolant C in upper die coolant path 64 to the outside through introduction and discharge pipe 65. Thus, the step of heating the upper die can be more quickly performed.

If the upper die is made of a copper-based material having high thermal conductivity, the step of heating the upper die can be even more quickly performed.

Next, as shown in FIGS. 15A and 15B, movable plate 7 is moved upward by die opening/closing mechanism 11 (see FIG. 1), to contact an upper surface of floating plate 91 with sealing member 53 in the lower surface of upper die plate 5 (first clamping step).

In the first clamping step, in an outer peripheral portion of the lower die cavity portion between the molding surfaces of upper and lower dies 6, 10, space within that portion is reliably sealed by sealing member 53. As a result, the space formed by upper and lower dies 6, 10 is shut off from outside air. Here, a lower surface of square substrate 20 is not contacted with the upper surface of floating plate 91.

Accordingly, air inside this sealed space and bubbles and the like contained in liquid thermosetting resin material R can be efficiently and forcibly discharged to the outside through the decompression action inside the lower die cavity (106) discussed above (step of decompressing the space between the surfaces of the upper and lower dies).

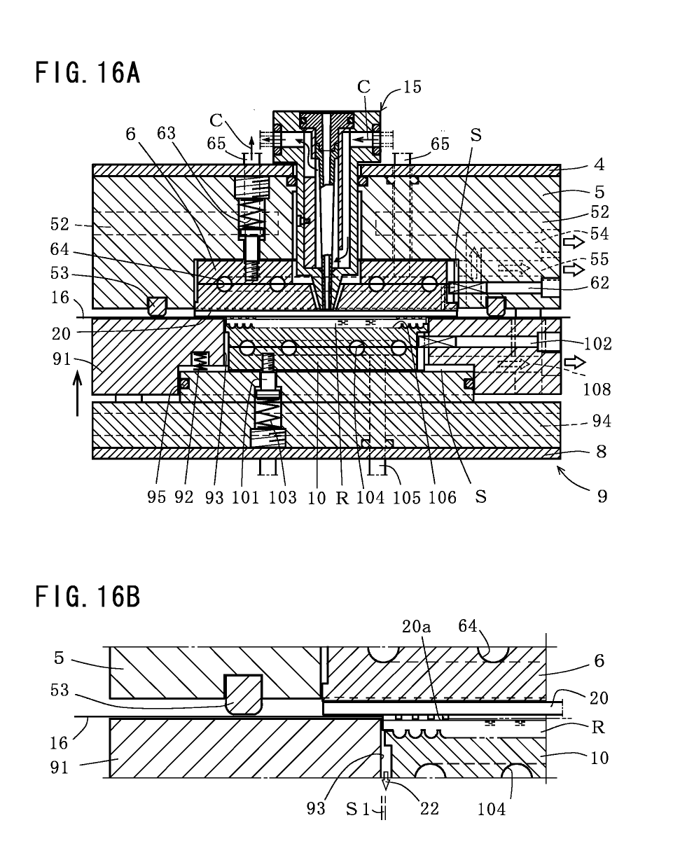

Next, as shown in FIGS. 16A and 16B, movable plate 7 is further moved upward by die opening/closing mechanism 11 (see FIG. 1), to contact the upper surface of floating plate 91 with the lower surface of square substrate 20 (second clamping step).

In the second clamping step, the above sealed space is decompressed, and electronic component 20a on the lower surface of the square substrate is immersed in liquid thermosetting resin material R in the lower die cavity (106) (step of immersing the electronic component).

This step of immersing the electronic component may be performed during a step of sealing and molding the electronic component with compression resin made of liquid thermosetting resin material R to be described later.

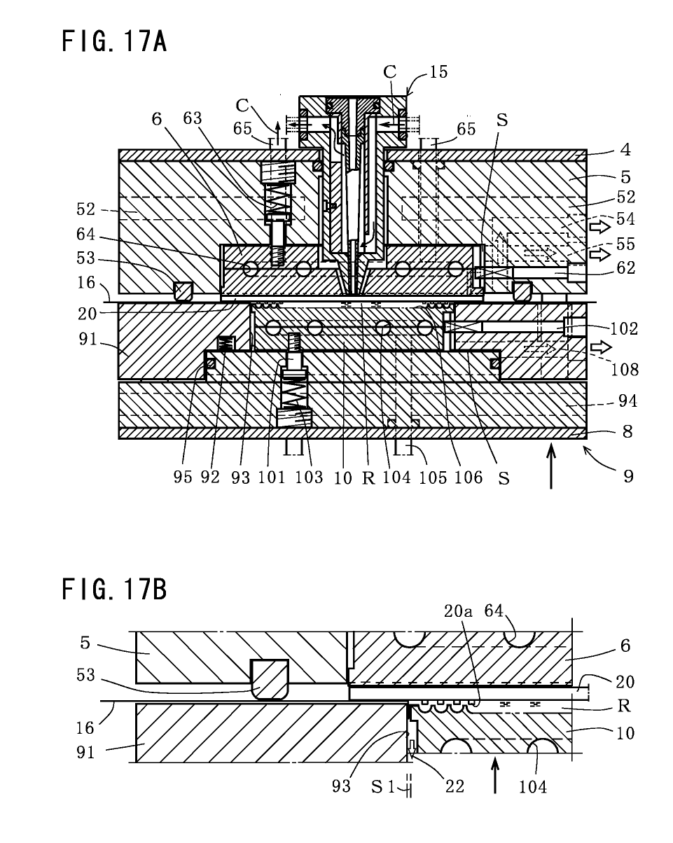

Next, as shown in FIGS. 17A and 17B, movable plate 7 is further moved upward by die opening/closing mechanism 11 (see FIG. 1), causing lower die plate 9 to move upward against the resilient projection force of resilient member 92 (third clamping step).

In the third clamping step, lower die plate 9 and lower die 10 are moved upward to compress liquid thermosetting resin material R in the lower die cavity (step of sealing and molding the electronic component with compression resin).

Here, electronic component 20a on the lower surface of the square substrate is immersed in liquid thermosetting resin material R in the lower die cavity which moves upward. As a result, electronic component 20a is sealed and molded with the liquid thermosetting resin material, while being gradually pressurized and applied with predetermined compression force. Accordingly, the step of immersing the electronic component discussed above may be performed prior to this compression resin sealing and molding step.

Next, gap S for air heat insulation is formed between upper die 6 and cartridge heater 52 for heating the upper die, and between lower die 10 and cartridge heater 94 for heating the lower die (first step of opening the dies). During the first step of opening the dies, upper die 6 and lower die 10 are cooled (step of cooling the upper die and step of cooling the lower die).

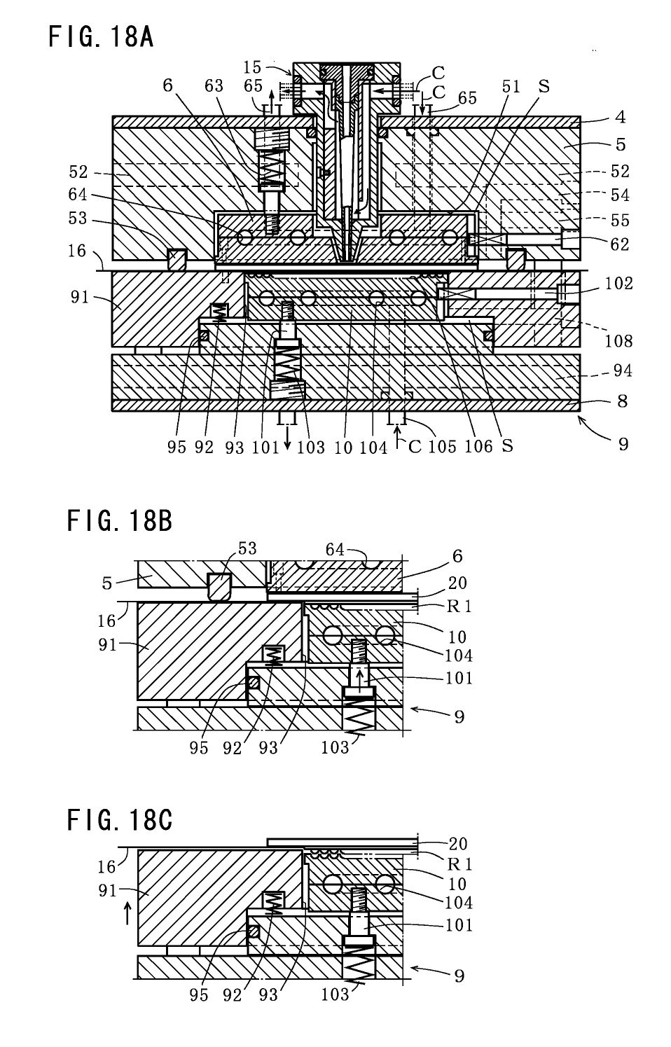

In the steps of cooling the upper and lower dies, as shown in FIGS. 18A and 18B, actuation of the vacuum motor (not shown) is stopped, causing the space within attachment hole portion 93 to make a transition from the decompressed state to a normal pressure state. Then, lower die 10 is moved upward from the upper surface of lower die plate 9 through the resilient projection force of resilient member 103, to form gap S between lower die 10 and lower die plate 9. Likewise, actuation of the vacuum motor (not shown) is stopped, causing the space within recess 51 in the upper die plate to make a transition from the decompressed state to a normal pressure state. As a result, upper die 6 is moved downward within recess 51 in upper die plate 5 through the resilient projection force of resilient member 63, to form gap S between upper die 6 and upper die plate 5. Through the air heat insulation action of gap S, thermal conduction from upper and lower plates 5, 9, i.e., from cartridge heaters 52, 94 to upper and lower dies 6, 10 can be efficiently suppressed.

In addition, by actuating the water supply and discharge pump (not shown), coolant C circulates through lower die coolant path 104 from introduction and discharge pipe 105. Thus, lower die 10 is forcibly cooled. Likewise, by actuating the water supply and discharge pump, coolant C circulates through upper die coolant path 64 from introduction and discharge pipe 65. Thus, upper die 6 is forcibly cooled. As a result, upper and lower dies 6, 10 are forcibly and quickly cooled.

With the holding of gap S between upper and lower dies 6, 10 and upper and lower plates 5, 9 by stopping actuation of the vacuum motor, and the forcible cooling of upper and lower dies 6, 10 by actuating the water supply and discharge pump discussed above, the steps of cooling the upper and lower dies can be quickly and reliably performed. If upper and lower dies 6, 10 are made of a copper-based material having high thermal conductivity, the steps of cooling upper and lower dies 6, 10 can be even more quickly and reliably performed.

As discussed above, when upper die 6 is moved downward through the transition from the decompressed state to the normal pressure state, the space within air intake hole 67 in the lower surface of the upper die also makes a transition from the decompressed state to a normal pressure state. Consequently, adsorption force on square substrate 20 is not generated, which allows easy removal of the square substrate.

FIG. 18C shows a state where upper and lower dies 6, 10 are opened to a further degree after the first step of opening the dies. Here, floating plate 91 moves upward relative to lower die 10 through the resilient projection force of resilient member 92. Thus, this rising of floating plate 91 acts to release a molded component for releasing a compression resin-sealed and molded component R1 integrated into the lower surface of the square substrate from the space within the lower die cavity (106).

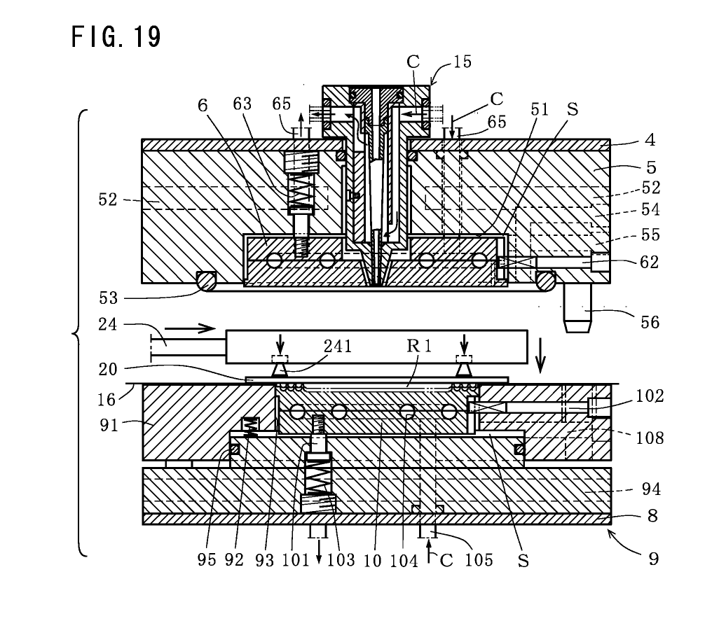

Next, as shown in FIG. 19, movable plate 7 is moved downward to separate upper and lower dies 6, 10 from each other. As a result, the upper and lower dies can be returned to their original positions (second step of opening the dies).

Next, the compression resin-sealed and molded electronic component is removed to the outside from the lower die cavity (106) portion having mold release film 16 set thereon (step of removing the molded component).

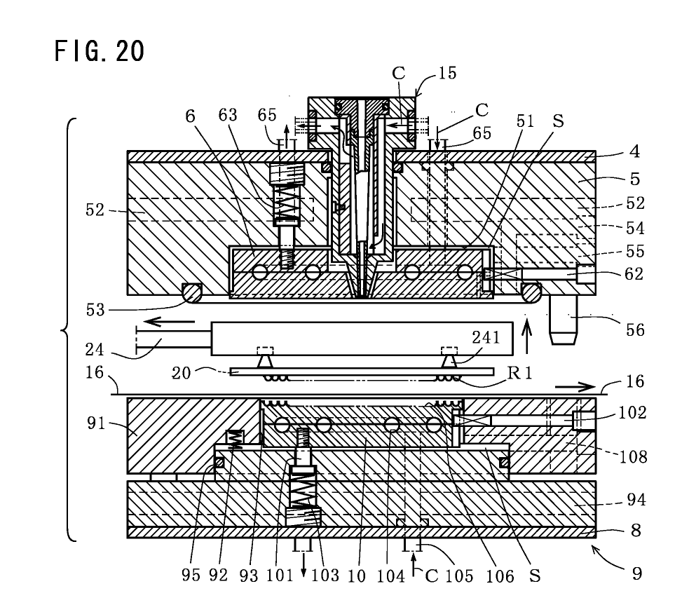

In this step of removing the molded component, as shown in FIG. 19, a molded component removing member 24 is inserted between upper and lower dies 6, 10 and is moved downward, causing an adsorption element 241 provided on a bottom surface of the molded component removing member to adsorb square substrate 20. Then, molded component removing member 24 is moved upward in this state, to release compression resin-sealed and molded electronic component R1 integrated into square substrate 20 from the lower die cavity (106) portion. Then, as shown in FIG. 20, molded component removing member 24 is retracted to remove the compression resin-sealed and molded electronic component, i.e., square substrate 20 having compression resin-sealed and molded component R1 integrated therein, to the outside.

When compression resin-sealed and molded component R1 is released from the lower die cavity (106) portion, upper and lower dies 6, 10 are quickly cooled in the cooling steps. Compression resin-sealed and molded component R1 thus tends to constrict due to the cooling. As a result, the compression resin-sealed and molded component is in a state in which it can readily be released from the lower die cavity (106) portion. Stated another way, cooling of compression resin-sealed and molded component R1 increases hardness thereof. When the compression resin-sealed and molded component is released from the die, therefore, accuracy of its shape and dimensions is maintained, thereby efficiently preventing disadvantages such as warping and deformation of the compression resin-sealed and molded component.

Therefore, after the steps of opening upper and lower dies 6, 10 are completed, this step of removing the molded component can be immediately started. A cycle time of overall resin molding is thus shortened, thereby implementing efficient production of electronic components.

When square substrate 20 is adsorbed by adsorption element 241 of molded component removing member 24, reverse procedure to the above such as moving lower die plate 9 upward to cause square substrate 20 to be adsorbed by adsorption element 241 of molded component removing member 24, for example, may be employed.

Upon completion of all the steps discussed above, subsequent molding operation is started. After or simultaneously with the operation of retracting molded component removing member 24 in the step of removing the molded component discussed above, mold release film setting mechanism 17 (see FIG. 2) may be actuated to supply new mold release film 16 on the surface of lower die 10, as shown in FIG. 20 (step of supplying the mold release film).

By employing the embodiment as described above, the compression resin-sealed and molded electronic component having high quality and high reliability can be formed efficiently and reliably, and size reduction and weight reduction of the entire compression resin sealing and molding apparatus can be attained. Therefore, the compression resin sealing and molding apparatus for an electronic component discussed above can be used as a so-called desktop molding apparatus.

In addition, resin sealing and molding can be performed depending on properties of a liquid resin material, and the thermosetting resin material can be efficiently supplied into the lower die cavity while maintaining its flowability. Further, hardness of the thermosetting resin-molded component can be increased through the cooling action, allowing efficient resin sealing and molding, and efficient release of the molded component from the space within the lower die cavity. As a result, a cycle time of overall resin molding is shortened, thereby attaining efficient production.

Moreover, the use of the mold release film can prevent adhesion of the resin material to the surface of the lower die. Accordingly, the resin-sealed and molded component can be reliably released, and a resin material having high adhesion to the cavity surface can be used.

Furthermore, the size reduction of the dies provides for an improved effective utilization ratio (yield) of the mold release film.

### Second Embodiment

A compression resin sealing and molding apparatus and a method using the same in a second embodiment will be described. In the step of supplying the liquid thermosetting resin material to the gate nozzle in the first embodiment, both the main agent and the curing agent are measured and mixed with each other before being sent to gate nozzle 15. However, when a resin material of one liquid is used, or when a powdered/particulate resin material used, the resin material in a measured required amount may be immediately sent to gate nozzle 15.

In this case, the resin material sent into gate nozzle 15 is immediately supplied from gate nozzle 15 into the lower die cavity (106) below, and is thus heated in the lower die cavity.

### Third Embodiment

A compression resin sealing and molding apparatus and a method using the same in a third embodiment will be described. As means for mixing the liquids in mixing and transferring unit 14 with each other in the first embodiment, other suitable mixing mechanism structures may be employed. The mixing mechanism should only be able to mix the liquids with each other as needed and sufficiently in the transfer path from measuring unit 13 through gate nozzle 15.

For example, the transfer path for the resin material discussed above may be formed as a helical transfer groove portion gradually descending downward, a back-and-forth transfer groove portion, a meandering transfer groove portion and the like (not shown). In this case, if the transfer path is sufficiently long, the liquids can be uniformly and efficiently mixed with each other while the measured liquid resin material flows through this transfer path and is transferred to gate nozzle 15.

By employing such helical transfer groove portion, back-and-forth transfer groove portion, and a meandering transfer groove portion as a structure and a shape of the transfer path, the length of the apparatus in a vertical direction can be shortened (apparatus height can be reduced). Thus, the transfer units described above are advantageous means for reducing size of the entire apparatus.

### Fourth Embodiment

A compression resin sealing and molding apparatus and a method using the same in a fourth embodiment will be described. A thermosetting resin material other than the thermosetting resin material such as a silicone resin discussed in the first embodiment can be used as a resin material. A thermoplastic resin material can also be used. A resin material may be selected as appropriate depending on an intended purpose.

### Fifth Embodiment

A compression resin sealing and molding apparatus and a method using the same in a fifth embodiment will be described. While the resin sealing and molding method of supplying the liquid resin material to the space within the lower die cavity (106) covered with mold release film 16 has been described in the first embodiment, a resin sealing and molding method without using mold release film 16 may be employed.

### Sixth Embodiment

A compression resin sealing and molding apparatus and a method using the same in a sixth embodiment will be described. In the first embodiment, mold release film mounting member 21, substrate mounting member 23 and molded component removing member 24 are separately provided. By integrating these structures into one another, further size reduction and simplification of the entire apparatus structure can be attained, and improvement in workability and productivity can be provided.

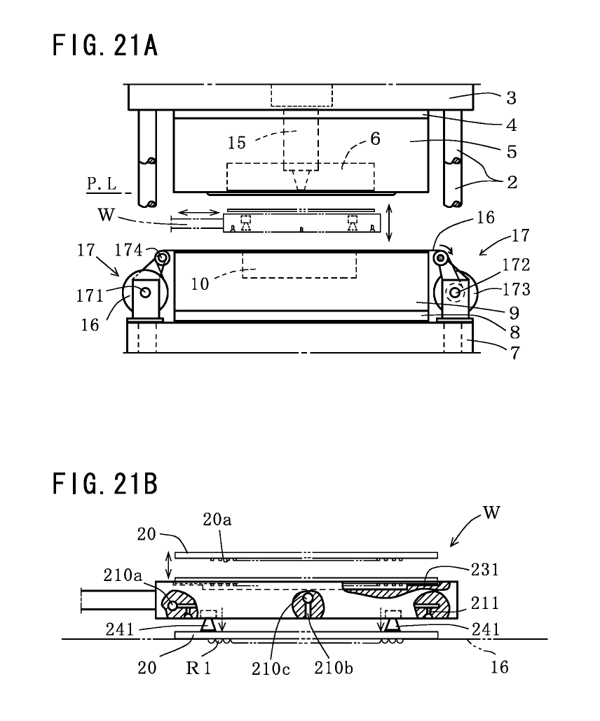

For example, an integrated structure W shown in FIGS. 21A and 21B has functions similar to those of mold release film mounting member 21, substrate mounting member 23, and molded component removing member 24 discussed above.

Integrated structure W includes a mold release film mounting mechanism for supplying mold release film 16 discussed above into the space within the lower die cavity (106) and mounting the film on the lower die cavity surface discussed above, a substrate supply mechanism for supplying square substrate 20 before resin sealing and molding to the lower surface of upper die 6 discussed above, and a molded component removal mechanism for removing square substrate 20 after resin sealing and molding from the lower die cavity surface discussed above to the outside.

In this case, therefore, the mold release film mounting step, the substrate supply step, and the molded component removal step performed by the respective mechanisms discussed above can all be performed only with integrated structure W without the need for special and dedicated members.

Thus, simplification of the apparatus structure or size reduction of the apparatus can be attained by employing such integrated structure W.

Constituent members the same as those discussed above are denoted with the same reference signs to avoid redundant description.

In FIG. 21B, a reference number 231 indicates a substrate accommodation unit for accommodating square substrate 20 during transfer and supply of square substrate 20. Substrate accommodation unit 231 may be varied in shape depending on a substrate shape.

### Seventh Embodiment

A compression resin sealing and molding apparatus and a method using the same in a seventh embodiment will be described. The compression resin sealing and molding apparatus for an electronic component in the present invention is reduced in size and weight as a whole, and can therefore be used as a so-called desktop molding apparatus. Thus, for low-volume production of each of various types of resin-sealed and molded components, for example, during operation of setting square substrate 20 in the lower die cavity (106) portion and operation of removing the resin-sealed and molded component, an ordinary loading flame (not shown) having a simplified structure may be used, for example, instead of the arrangement and structures of substrate mounting member 23 and molded component removing member 24. As a result, a structure without the need for an automated machine such as an inloader mechanism and an unloader mechanism may be employed.

Although the present invention has been described and illustrated in detail, it is clearly understood that the same is by way of illustration and example only and is not to be taken by way of limitation, the scope of the present invention being interpreted by the terms of the appended claims.

### INDUSTRIAL APPLICABILITY

According to the present invention, a compression resin sealing and molding apparatus for an electronic component reduced in size and weight can be realized. The apparatus according to the present invention can thus be used as a desktop compression resin sealing and molding apparatus.

### DESCRIPTION OF THE REFERENCE SIGNS

1 base; 2 tie-bar; 3 fixed plate; 4 upper die heat insulation plate; 5 upper die plate; 51 recess; 52 cartridge heater; 53 sealing member for shutting off outside air; 54 air intake pathway; 55 air intake pathway; 56 upper die guide pin; 57 removably fit unit; 6 upper die; 61 fixing pin; 62 positioning pin; 63 resilient member; 64 coolant path; 65 introduction and discharge pipe for coolant; 66 pilot pin; 67 air intake hole; 68 central opening in upper die; 7 movable plate; 8 lower die heat insulation plate; 9 lower die plate; 91 floating plate; 92 resilient member; 93 attachment hole portion; 94 cartridge heater; 95 sealing member; 10 lower die; 101 fixing pin, 102 positioning pin; 103 resilient member; 104 coolant path; 105 introduction and discharge pipe for coolant; 106 space in resin molding surface (lower die cavity); 107 lower die guide pin; 108 air intake pathway; 11 die opening/closing mechanism; 12 containing unit for liquid resin material; 121 containing tank for liquid resin material; 122 containing tank for liquid curing agent; 13 measuring unit for liquid resin material; 131 opening/closing valve; 132 opening/closing valve; 14 mixing and transferring unit for liquid resin material; 141 opening/closing valve; 142 rotating impeller blade; 15 gate nozzle; 151 gate nozzle body; 152 sealing member; 153 lower end nozzle unit; 154 coolant introduction and discharge unit; 154a coolant pipe; 155 coolant path member; 156 nozzle chip; 156a liquid resin material discharge hole; 157 holding member; 157a communication hole; 16 mold release film; 17 mold release film setting mechanism; 171 mold release film supply roller; 172 mold release film winding roller; 173 motor; 174 tension roller; 18 control unit; 19 operation panel unit; 20 square substrate; 20a electronic component; 21 mold release film mounting member; 210a air intake path; 210b compressed air ejection hole; 210c compressed air supply path; 211 suction hole; 211a suctioned state; 211b fitted state; 22 suction force; 23 substrate mounting member; 231 substrate accommodation unit; 24 molded component removing member; 241 adsorption element; A compressed air; A1 compressed air; C coolant; R liquid thermosetting resin material; R1 compression resin-sealed and molded component; S gap; S1 gap; W integrated structure.

1. A compression resin sealing and molding method for an electronic component for immersing an electronic component mounted on a substrate in a liquid resin material in a cavity of a lower die, and applying predetermined heat and pressure to said liquid resin material to seal and mold said electronic component with compression resin, comprising the steps of:
supplying said liquid resin material from a gate nozzle in an upper die provided opposite to said lower die into said cavity; and
sealing and molding said electronic component on said substrate with compression resin by closing said upper die and said lower die,
in said supplying step and said sealing and molding step with compression resin, a temperature of said liquid resin material flowing through said gate nozzle and temperatures of said upper die and said lower die are controlled.

2. The compression resin sealing and molding method for an electronic component according to claim 1, wherein
the temperature of said liquid resin material flowing through said gate nozzle and the temperatures of said upper die and said lower die are simultaneously controlled.

3. The compression resin sealing and molding method for an electronic component according to claim 1, wherein
the temperature of said liquid resin material flowing through said gate nozzle and the temperature of said upper die and said lower die are independently controlled.

4. The compression resin sealing and molding method for an electronic component according to claim 1, wherein
said liquid resin material is a liquid thermosetting resin material, and
thermosetting reaction of said liquid thermosetting resin material flowing through said gate nozzle is suppressed by a mechanism for cooling said gate nozzle.

5. The compression resin sealing and molding method for an electronic component according to claim 1, further comprising the step of, after said sealing and molding step with compression resin, cooling at least one of said upper die and said lower die by a cooling mechanism provided in each of said upper die and said lower die.

6. The compression resin sealing and molding method for an electronic component according to claim 1, wherein
said supplying step includes the steps of
measuring said liquid resin material contained in a portion for containing said liquid resin material, and
sending said liquid resin material subjected to said measuring step to said gate nozzle.

7. The compression resin sealing and molding method for an electronic component according to claim 6, wherein
upon completion of said sending step, remaining said liquid resin material is sent to said gate nozzle by compressed air.

8. The compression resin sealing and molding method for an electronic component according to claim 1, wherein
said supplying step includes the steps of
measuring a main agent in the liquid resin material contained in a first tank and a liquid curing agent contained in a second tank,
mixing said main agent in the liquid resin material and said liquid curing agent subjected to said measuring step with each other to produce a liquid thermosetting resin material, and
sending said liquid thermosetting resin material to the gate nozzle.

9. The compression resin sealing and molding method for an electronic component according to claim 8, wherein
upon completion of said sending step, remaining said liquid thermosetting resin material is sent to said gate nozzle by compressed air.

10. The compression resin sealing and molding method for an electronic component according to claim 1, wherein
said liquid resin material is supplied into said cavity, with a molded-component release film being set on a surface of said cavity.

11. A compression resin sealing and molding apparatus for an electronic component for immersing an electronic component mounted on a substrate in a liquid resin material in a cavity, and applying predetermined heat and pressure to said liquid resin material to seal and mold said electronic component with compression resin, comprising:
an upper die and a lower die arranged opposite to each other in a vertical direction;
a gate nozzle for supplying the liquid resin material arranged in said upper die;
a cavity for setting a single substrate, arranged in said lower die and being supplied with said liquid resin material from said gate nozzle;
a mechanism for controlling a temperature of said liquid resin material flowing through said gate nozzle; and
a mechanism for controlling a temperature of each of said upper die and said lower die.

12. The compression resin sealing and molding apparatus for an electronic component according to claim 11, wherein
said liquid resin material is a liquid thermosetting resin material, and
said gate nozzle includes a cooling mechanism for suppressing thermosetting reaction of said liquid thermosetting resin material flowing through said gate nozzle.

13. The compression resin sealing and molding apparatus for an electronic component according to claim 11, wherein
said gate nozzle includes
a gate nozzle body provided in a manner readily attachable/detachable with respect to a removably fit unit provided in a structure having said upper die mounted thereon,
a coolant path member provided inside said gate nozzle body,
a nozzle chip for discharging the liquid resin material fitted in a manner readily attachable/detachable with respect to said coolant path member, and
a holding member for fixing said nozzle chip to said coolant path member.

14. The compression resin sealing and molding apparatus for an electronic component according to claim 13, wherein
when said gate nozzle body is fitted in said removably fit unit, a lower end nozzle unit of said gate nozzle body is positioned in an opening in a vertical direction formed in said upper die, and is provided not to project from a lower surface of said upper die.

15. The compression resin sealing and molding apparatus for an electronic component according to claim 13, wherein
when said nozzle chip is held in said coolant path member by said holding member, a communication hole formed in a central portion of said holding member is in communication with a liquid resin material discharge hole in said nozzle chip.

16. The compression resin sealing and molding apparatus for an electronic component according to claim 13, wherein
said nozzle chip is formed to be tapered downward.

17. The compression resin sealing and molding apparatus for an electronic component according to claim 13, wherein
said nozzle chip is made of a water-repellent material.

18. The compression resin sealing and molding apparatus for an electronic component according to claim 13, wherein
a coolant introduction and discharge unit connected to a coolant pipe is provided on an upper end portion of said gate nozzle body.

19. The compression resin sealing and molding apparatus for an electronic component according to claim 11, wherein
a cooling mechanism is provided in each of said upper die and said lower die.

20. The compression resin sealing and molding apparatus for an electronic component according to claim 11, further comprising a mechanism for setting a molded-component release film on at least a surface of said cavity.

21. The compression resin sealing and molding apparatus for an electronic component according to claim 11, wherein
in said mechanism for controlling the temperature of each of said upper die and said lower die,
said upper die is provided to form a floating structure with respect to an upper die plate including an upper die heating heater,
said upper die includes a coolant path, which is connected to a coolant introduction and discharge pipe,
said lower die is provided to form a floating structure with respect to a lower die plate including a lower die heating heater,
said lower die includes a coolant path, which is connected to a coolant introduction and discharge pipe, and
a heating mechanism for contacting said upper die and said lower die with said upper die plate and said lower die plate, respectively, is provided.

22. The compression resin sealing and molding apparatus for an electronic component according to claim 21, wherein
said heating mechanism may contact said upper die with said upper die plate and contact said lower die with said lower die plate by decompressing space between said upper die and said upper die plate and space between said lower die and said lower die plate, respectively.

23. The compression resin sealing and molding apparatus for an electronic component according to claim 11, wherein
each of said upper die and said lower die is made of a copper-based material.

24. The compression resin sealing and molding apparatus for an electronic component according to claim 11, further comprising an integrated structure, wherein
said integrated structure includes
a mechanism for supplying a mold release film to a surface of said cavity,
a mechanism for supplying said substrate before resin sealing and molding to said upper die, and
a mechanism for removing said substrate after resin sealing and molding from said lower die, and
said integrated structure is provided to be able to advance into space between said upper die and said lower die and retract from the space between said upper die and said lower die.

25. A compression resin sealing and molding method for an electronic component for, using an apparatus in which a cavity for setting a single substrate is provided in a lower die for resin sealing and molding, and a gate nozzle for supplying a liquid resin material is arranged in an upper die provided opposite to said lower die, immersing an electronic component mounted on the substrate in a liquid resin material supplied into said cavity, and applying predetermined heat and pressure to said liquid resin material to seal and mold said electronic component with compression resin, comprising the steps of:
cooling said upper die and said lower die, with a gap for air heat insulation being present between said upper die and an upper die heating heater and between said lower die and a lower die heating heater;
cooling said gate nozzle;
separating said upper die and said lower die from each other;
heating said lower die with heat from said lower die heating heater to a resin molding temperature by eliminating the gap for air heat insulation between said lower die and said lower die heating heater;
supplying the liquid resin material into said cavity through said gate nozzle;
setting said substrate having said electronic component mounted thereon in a predetermined position of a molding surface of said upper die;
heating said upper die with heat from said upper die heating heater to the resin molding temperature by eliminating said gap for air heat insulation between said upper die and said upper die heating heater;
a first clamping step of hermetically sealing at least space within the cavity between said upper die and said lower die with a sealing member by contacting said upper die with said lower die;
decompressing the space hermetically sealed with said sealing member;
a second clamping step of contacting the substrate set on said upper die with a molding surface of peripheral portion of said cavity; and
a third clamping step of compressing the liquid resin material in said cavity,
said second clamping step and/or said third clamping step including the step of immersing said electronic component in the liquid resin material in said cavity,
said third clamping step including the step of sealing and molding said electronic component with compression resin,
said method further comprising the step of
forming said gap for air heat insulation between said upper die and the upper die heating heater and between said lower die and the lower die heating heater,
said step of forming said gap including the step of cooling said upper die and said lower die,
said method further comprising the steps of
opening said upper die and said lower die, and
removing the sealed and molded electronic component with compression resin from within said cavity to the outside.

26. The compression resin sealing and molding method for an electronic component according to claim 25, wherein
after said step of separating said upper die and said lower die from each other, a mold release film is supplied to a surface of said cavity.

27. The compression resin sealing and molding method for an electronic component according to claim 26, further comprising the step of, after said mold release film is supplied, fitting said mold release film to a surface of said cavity by supplying compressed air to said mold release film set on the surface of said cavity with said mold release film being adsorbed to the molding surface of the peripheral portion of the cavity in said lower die.

28. The compression resin sealing and molding method for an electronic component according to claim 27, wherein
in said fitting step, said mold release film is forcibly suctioned toward the surface of said cavity through decompression action.

29. The compression resin sealing and molding method for an electronic component according to claim 25, wherein
after said step of supplying said liquid resin material into said cavity, or upon completion of said step of supplying said liquid resin material into said cavity, said gate nozzle is decompressed to prevent leakage of said liquid resin material remaining in said gate nozzle.

30. The compression resin sealing and molding method for an electronic component according to claim 25, wherein
said liquid resin material is a thermosetting resin material.

31. The compression resin sealing and molding method for an electronic component according to claim 25, wherein
in said step of cooling said upper die and said lower die, said upper die and said lower die are cooled through air heat insulation action of the gap between said upper die and an upper die plate and the gap between said lower die and a lower die plate, respectively, and/or through forcible cooling action by a coolant introduced into said upper die and said lower die, respectively.

32. The compression resin sealing and molding method for an electronic component according to claim 25, wherein
in said step of heating said upper die to the resin molding temperature and in said step of heating said lower die to the resin molding temperature, heat is conducted from an upper die plate to said upper die and heat is conducted from a lower die plate to said lower die by contacting said upper die with said upper die plate and by contacting said lower die with said lower die plate, respectively.

33. The compression resin sealing and molding method for an electronic component according to claim 25, wherein
each of said upper die and said lower die is made of a copper-based material, to facilitate heating and cooling of said upper die and said lower die.
